(19) United States
(12) Patent Application Publication
(10) Pub. No.: US 2007/0099793 A1
(43) Pub. Date: May 3, 2007

(54) LOW THERMAL EXPANSION FOUNDRY MEDIA

(75) Inventor: Brett Allen Wilson, Lafayette, LA (US)

Correspondence Address: HAYNES AND BOONE, LLP, 901 MAIN STREET, SUITE 3100, DALLAS, TX, 75202, US

(73) Assignee: CARBO CERAMICS INC., Irving, TX (US)

(21) Appl. No.: 11/551,190

(22) Filed: Oct. 19, 2006

Related U.S. Application Data
(60) Provisional application No. 60/728,291, filed on Oct. 19, 2005.

(51) Int. Cl. C04B 35/119; C04B 35/03; C04B 35/64

(52) U.S. Cl. 501/118; 501/119; 264/681

(57) ABSTRACT

Foundry media having a low coefficient of thermal expansion, and methods and materials for producing the media.

### BACKGROUND

The present disclosure relates to foundry media having a low coefficient of thermal expansion, and methods and materials for producing the media.

Foundry media is used in various casting processes in the metal casting industry. In casting processes, molten metal is poured into a molded area in the presence of the foundry media to produce a casting of designed shape, size and dimensions. As the molten metal is poured into a mold, the foundry media is heated and will expand. When the metal and mold cool to room temperature, the metal and the mold will contract. The expansion and contraction on heating and cooling can result in defects in the resulting cast metal part.

The degree of expansion that can occur varies by type of foundry media. The coefficient of thermal expansion represents the amount a material will expand or contract upon heating or cooling. Use of a media with a high coefficient of thermal expansion requires more extensive pre-engineering of part dimensional designs and additives to best account for the impact of expansion. Foundry media with smaller values in the coefficient of thermal expansion will have less expansion and contraction during use as a molten metal mold material, and should result in fewer defects in the final metal part.

Silica sand, the most common media used for metal casting applications, has a coefficient of thermal expansion of greater than ten (10⁻⁶ inch per inch per ° C.). Zircon sand, the most common specialty sand used in the metal casting applications, has a coefficient of thermal expansion of around 4.2 (10⁻⁶ inch per inch per ° C.). Still other known foundry media include a synthetic ceramic media commercially available from CARBO Ceramics, Inc. under the tradename ACCUCAST®.

High thermal expansion properties can limit the ability to produce castings with thin walls or very complex parts requiring high levels of dimensional precision. High expansion media may require additives to buffer the media expansion or high machining and cleaning cost to correct for poor resulting cast properties. Foundry media having a lower thermal expansion can benefit the foundry industry through: (1) reduced casting defects; (2) reduced pre-engineering cost; (3) enhanced thin wall capabilities; (4) enhanced capability for producing castings of high complexity; (5) reduced use of high cost expansion buffer additives; or (6) reduced use of costly and time consuming washes and their associated equipment and workers.

### BRIEF DESCRIPTION OF THE DRAWINGS

FIG. 1 is a simplified illustration of a magnesia-alumina-silica phase diagram.

FIG. 2 illustrates a comparison of CTEs and percents of linear change as a function of temperature for conventional foundry media and foundry media according to the present embodiments.

FIG. 3 illustrates a cross-section of an aluminum step cone cast with a core made from sintered pellets of the present invention (Example 4) revealing no penetration or veining defects.

FIG. 4 illustrates a cross-section of an aluminum step cone cast with a core made from zircon sand revealing slight penetration defects in several of the rings and no veining defects.

FIG. 5 illustrates a cross-section of an iron step cone cast with a core made from sintered pellets of the present embodiments (Example 4) with a graphite coating revealing little to no penetration and no veining defects.

FIG. 6 illustrates a cross-section of an iron step cone cast with a core made from silica sand with a coating of zircon wash revealing slight penetration defects in several of the rings and moderate to severe veining defects.

FIG. 7 illustrates a schematic view of an exemplary system for implementing a continuous process using a fluid bed to prepare foundry media according to the present embodiments.

FIG. 8 illustrates a schematic view of a drying chamber providing a combination of co-current and counter-current flow for use in forming foundry media as described herein using spray drying methods.

FIG. 9 illustrates a schematic view of a drying chamber providing a co-current flow for use in forming foundry media as described herein using spray drying methods.

### DETAILED DESCRIPTION

Methods for making a foundry media with a low coefficient of thermal expansion and a foundry media so made are described. Certain embodiments describe methods for making a foundry media that include forming substantially round and spherical green pellets from raw materials that include a magnesia source, a silica source and an alumina source and then sintering the green pellets to form the foundry media. Certain embodiments describe methods for making a foundry media and a foundry media so made with a coefficient of thermal expansion, from about 100° C. to about 1100° C., less than the coefficient of thermal expansion of at least one of silica sand, zircon sand and olivine sand. Certain other embodiments describe methods for making a foundry media and a foundry media so made having a coefficient of thermal expansion less than about 4.0 (10⁻⁶ inch per inch per ° C.) from about 100° C. to about 1100° C.

Certain other embodiments describe methods for making a foundry media and a foundry media so made wherein the foundry media has a coefficient of thermal expansion, from about 100° C. to about 1100° C., selected from the group consisting of: less than about 15 (10⁻⁶ inch per inch per ° C.), less than about 12 (10⁻⁶ inch per inch per ° C.), less than about 7 (10⁻⁶ inch per inch per ° C.), less than about 6 (10⁻⁶ inch per inch per ° C.), less than about 5 (10⁻⁶ inch per inch per ° C.), and less than about 4.0 (10⁻⁶ inch per inch per ° C.).

Foundry media as described herein comprises substantially round and spherical sintered pellets formed from raw materials comprising a magnesia (MgO) source, a silica (SiQ₂) source, and an alumina (Al₂O₃) source, each of which is present in an amount sufficient to provide a net chemistry that, when the pellets are sintered, forms cordierite in an amount of at least 25 weight percent. The foundry media has a coefficient of thermal expansion from about 100° C. to about 1100° C., less than the coefficient of thermal expansion of at least one of silica sand, zircon sand and olivine sand. In certain embodiments, the amount of cordierite formed is at least about 40, 45, 50, 55, 60, 65, 70, 75, 80 or 85 weight percent. In still other embodiments, the amount of cordierite formed is at least about 7, 20 or 30 weight percent.

According to still other embodiments, foundry media comprising cordierite in an amount of from about 52 to about 66% by weight, mullite in an amount of from about 7 to about 24% by weight, and sapphirine in an amount of from about 1 to about 8% by weight is provided. According to one such embodiment, cristobalite, if any, is present in an amount of less than about 1% by weight.

According to still other embodiments, foundry media comprising cordierite in an amount of from about 25 to about 42% by weight, mullite in an amount of from about 19 to about 21% by weight and sapphirine in an amount of from about 7 to about 11% by weight is provided. According to one such embodiment, cristobalite, if any, is present in an amount of less than about 1% by weight.

According to still other embodiments, foundry media comprising cordierite in an amount of from about 80 to about 90% by weight, mullite in an amount of from about 3 to about 10% by weight, and sapphirine in an amount of from about 0 to about 16% by weight is provided. According to one such embodiment, cristobalite, if any, is present in an amount of less than about 1% by weight.

According to still other embodiments, foundry media comprising cordierite in an amount of about 64% by weight, mullite in an amount of about 20% by weight, and cristobalite in an amount of about 7% by weight. According to one such embodiment, sapphirine, if any, is present in an amount of less than about 1% by weight.

According to still other embodiments, foundry media comprising cordierite in an amount of about 82% by weight, mullite in an amount of about 13% by weight, and cristobalite in an amount of about 5% by weight. According to one such embodiment, sapphirine, if any, is present in an amount of less than about 1% by weight.

According to still other embodiments described herein, the net chemistry of the magnesia source, the silica source and the alumina source falls into certain regions of a magnesia-alumina-silica phase diagram. A magnesia-alumina-silica phase diagram is known to those of ordinary skill in the art to illustrate the phases that would result from equilibrium chemical reactions for the compositions and temperatures shown in the diagram. The magnesia-alumina-silica phase diagram is available in full detail from such commercial sources as ACerS-NIST Phase Equilibria Diagrams CD-ROM Database Version 3 and Phase Equilibria Diagrams: Volume I, Oxides and Salts, the American Ceramic Society, Ernest M. Levin, Carl R. Robbins, and Howard F. McMurdie (Eds.), (1964).

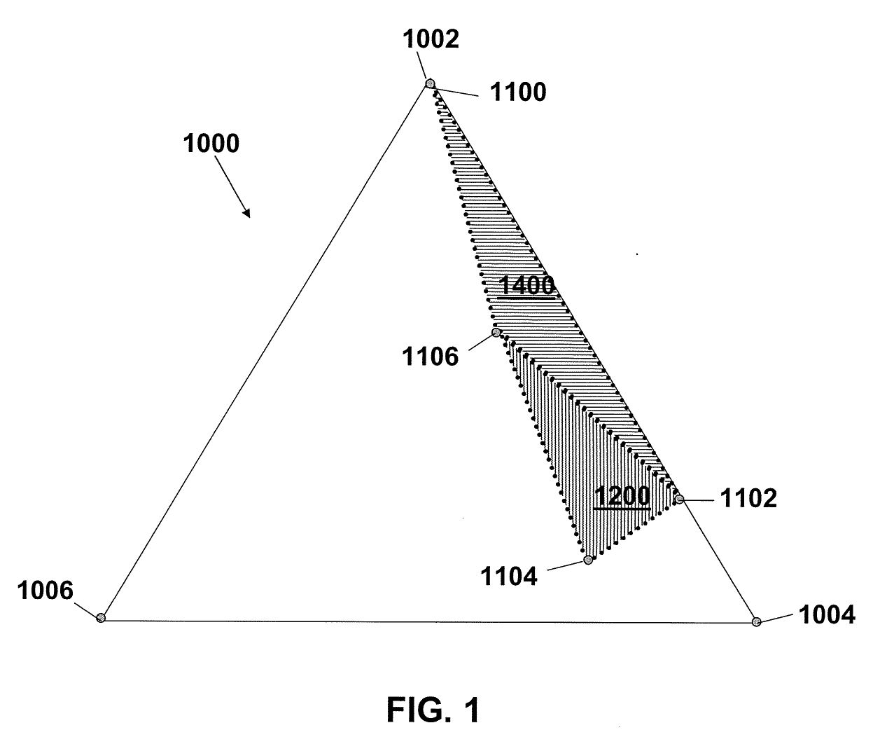

Referring now to FIG. 1, a magnesia-alumina-silica phase diagram 1000 is illustrated, which, for purposes of clarity, has been simplified with respect to the full detail magnesia-alumina-silica phase diagram known to those of ordinary skill in the art. In particular, the magnesia-alumina-silica phase diagram 1000 illustrated in FIG. 1 has been simplified to remove the illustration of the temperature axis that appears in the full detail phase diagram, and to illustrate only the phases that are of primary interest herein, namely, cristobalite (100% SiO₂), mullite (71.8% Al₂O₃, 28.2% SiO₂, 0% MgO), sapphirine, (64.4% Al₂O₃, 15.2% SiO₂, 20.4% MgO) and cordierite, (34.8% Al₂O₃, 51.4% SiO₂, 13.8% MgO). As to temperature, the temperature axis does not need to be illustrated in FIG. 1 because it is assumed that the phases illustrated in FIG. 1 are those phases that are expected after heating of materials at a high enough temperature and slow enough rate, and cooling at a slow enough rate such that the equilibrium chemical reactions that result in the illustrated phases occur. It shall be understood that a phase or point located on the magnesia-alumina-silica phase diagram 1000 illustrated in FIG. 1 is correspondingly located on the full detail magnesia-alumina-silica phase diagram.

FIG. 1 illustrates the endpoints of the phase diagram, namely, silica 1002, alumina 1004 and magnesia 1006. Point 1100 illustrates the location of cristobalite. Point 1102 illustrates the location of mullite. Point 1104 illustrates the location of sapphirine. Point 1106 illustrates the location of cordierite. Collectively, points 1104, 1102 and 1106 define the sapphirine-mullite-cordierite region 1200 of the magnesia-alumina-silica phase diagram, while points 1100, 1102 and 1106 define the cristobalite-mullite-cordierite region 1400 of the magnesia-alumina-silica phase diagram.

According to certain embodiments described herein, the net chemistry of the magnesia source, the silica source and the alumina source falls in the cristobalite-mullite-cordierite region 1400 of the magnesia-alumina-silica phase diagram 1000. For example, in some such embodiments, the net chemistry of the magnesia source, silica source and alumina source is such that magnesia (MgO) will be present in an amount of from about 7 to about 14% by weight, alumina (Al₂O₃) will be present in an amount of from about 17 to about 54% by weight, and silica (SiO₂) will be present in an amount of from about 39 to about 76% by weight. According to some such embodiments, the above net chemistry will produce a sintered product having at least 50% cordierite by weight, and will also have mullite and cristobalite present. Those of ordinary skill in the art will recognize that the presence of other oxides in small amounts from impurities in the magnesia, alumina and silica sources can shift the amounts of the phases that are present.

According to other embodiments, the net chemistry of the magnesia source, the silica source and the alumina source falls in the sapphirine-mullite-cordierite region 1200 of the magnesia-alumina-silica phase diagram 1000. For example, in some such embodiments, the net chemistry of the magnesia source, silica source and alumina source is such that magnesia will be present in an amount of from about 7 to about 18% by weight, alumina will be present in an amount of from about 34 to about 54% by weight, and silica will be present in an amount of from about 33 to about 52% by weight. According to some such embodiments, the above net chemistry will produce a sintered product having at least 50% cordierite by weight, and will also have mullite and sapphirine present. Those of ordinary skill in the art will recognize that the presence of other oxides in small amounts from impurities in the magnesia, alumina and silica sources can shift the amounts of the phases that are present.

According to certain embodiments, kaolin and/or bauxite is used as the alumina source. Exemplary magnesia sources include magnesium oxide, talc and olivine sand. In certain embodiments, talc, kaolin, bauxite and/or olivine sand are used as a silica source.

In certain methods, the raw materials are milled together to form a co-milled blend, which is then subsequently processed into foundry media. In other methods, the raw materials are blended together during the process for forming foundry media.

In certain methods, the substantially round and spherical pellets are formed by mixing the water, the magnesia source, the alumina source and the silica source in a high intensity mixer.

In certain methods, the substantially round and spherical pellets are formed by forming a slurry that includes the water, the magnesia source, the alumina source and the silica source, and feeding the slurry through an atomizer to form the pellets.

In certain embodiments, the substantially round and spherical pellets are formed by forming a slurry that includes the water, the magnesia source, the alumina source and the silica source, and feeding the slurry through a spray dryer to form the pellets.

Any of the raw materials can be calcined, uncalcined, partially calcined, or mixtures thereof. For example, in those embodiments where kaolin and/or bauxite are used, one or both can be calcined, uncalcined or partially calcined. In certain methods, substantially round and spherical green pellets are formed, via a mixing process, from raw materials comprising calcined kaolin and calcined bauxite, and providing a net chemistry as described herein. In other methods, substantially round and spherical green pellets are formed from raw materials providing a net chemistry as described herein via a spray drying process or fluid bed process in which uncalcined kaolin and/or uncalcined bauxite are used.

Green pellets made by any of the foregoing methods are sintered to final form at temperatures sufficient to sinter the pellets without melting. Sintering can be performed in a rotary kiln, a box kiln, or other suitable device that can provide appropriate sintering conditions. Sintering and equipment to perform sintering are known to those of ordinary skill in the art. For example, see U.S. Pat. No. 4,427,068 to Fitzgibbon. In certain embodiments, sintering can be performed at a temperature in the range of from about 1300° C. to about 1420° C. for a time in the range of from about 20 to about 45 minutes at peak temperature.

The foundry media formed according to methods described herein can be coated with a resin, and formed into a mold. Methods for coating foundry media and forming molds therefrom are known to those of ordinary skill in the art. The foundry media formed according to the methods described herein can also be used in methods for lost foam casting by packing the foundry media around a foam shape for casting. Methods for lost foam casting are known to those of ordinary skill in the art.

The following examples are illustrative of the methods and compositions discussed above.

Exemplary Raw Materials

The chemical analysis and loss on ignition of exemplary raw materials used to prepare substantially round and spherical pellets and bars according to exemplary methods described herein are reported in weight percents in Table 1.

The kaolin indicated in Table 1 as Kaolin C is commercially available from CE Minerals, Andersonville, Ga. Kaolin M is a kaolin mined from Central Georgia also known as Middle Georgia, having the chemical analysis reported in Table 1. Talc, which is generally referred to as hydrated magnesium silicate, was obtained from three sources. Talc A is Pioneer 2882 talc, which is commercially available from Zemex Industrial Minerals. Talc B is Wold talc, which is commercially available from Wold Talc Company. Talc C is a talc commercially available from Polar Minerals as talc 9202. Olivine sand, which is also known as magnesium iron silicate, was obtained from Unimin. The magnesium oxide used in this Example 1 is commercially available from Martin Marietta Magnesia Specialties under the tradename MagChem 40. The bauxite was obtained from Comalco.

TABLE 1
Chemical Analysis of Raw Materials (wt. %)

| | MgO | Al₂O₃ | SiO₂ | CaO | Na₂O | K₂O | TiO₂ | Fe₂O₃ | Other | LOI |
|---|---|---|---|---|---|---|---|---|---|---|
| Kaolin C | 0.07 | 45.60 | 51.21 | 0.05 | 0.07 | 0.17 | 1.86 | 0.96 | 0.01 | 2 |
| Kaolin M | 0.05 | 45.72 | 50.65 | 0.15 | — | 0.04 | 2.37 | 0.12 | 0.1 | 3.2 |
| Talc A | 27.24 | 1.25 | 61.14 | 9.68 | — | — | — | 0.69 | — | 11.5 |
| Talc B | 32.33 | 0.67 | 64.48 | 1.77 | 0.32 | 0.07 | — | 0.28 | 0.08 | 9.7 |
| Talc C | 35 | 0.70 | 61.5 | 1.00 | — | — | — | 0.50 | 1.20 | 7 |
| Olivine | 48.52 | 0.19 | 42.97 | 0.02 | 0.02 | 0.01 | — | 7.76 | 0.51 | 1.05 |
| Sand | | | | | | | | | | |
| MgO | 98.64 | 0.08 | 0.28 | 0.83 | — | — | — | 0.17 | — | 1.25 |
| Bauxite | 0.04 | 82.21 | 7.21 | 0.01 | — | — | 3.63 | 6.72 | 0.18 | 2 |

The percentages reported for the kaolins and bauxite were determined by inductively coupled plasma-optical emission spectra (ICP or ICP-OES), which is an analytical method known to those of ordinary skill in the art. The remaining reported percentages are those provided by the source of the raw material.

### EXAMPLE 1

### Pellets

Eight blends were prepared by jet-milling the raw materials described in Table 1, in the weight percents reported in Table 2A. Other suitable equipment and methods for co-milling raw materials such as the kaolin, talc and bauxite described herein are known to those of ordinary skill in the art. The bauxite and kaolin were calcined prior to jet-milling with the other raw materials at times and temperatures sufficient to substantially remove organic material and water of hydration. The other raw materials were uncalcined.

As indicated in Table 2A, Kaolin C was used for all eight blends. Talc A was used for Blend Nos. 1, 2 and 5, and Talc B was used for Blend Nos. 3, 7 and 8. Equipment and methods for jet-milling raw materials such as those described herein are known to those of ordinary skill in the art. In this example, the raw materials were jet-milled in a Sturtevant Inc. 4″ Open Manifold Micronizer using a feed rate of about one pound per hour.

TABLE 2A
Blends of Raw Materials

| | 1 | 2 | 3 | 4 | 5 | 6 | 7 | 8 |
|---|---|---|---|---|---|---|---|---|
| Kaolin | 60.1 (C) | 55.0 (C) | 54.6 (C) | 86.9 (C) | 63.2 (C) | 63.2(C) | 65.4 (C) | 75.6 (C) |
| Talc | 17.4 (A) | 16.4 (A) | 16.2 (B) | 0 | 17.4 (A) | 0 | 8.1 (B) | 8.1 (B) |
| Olivine | 0 | 0 | 0 | 0 | 0 | 23.5 | 0 | 0 |
| Sand | | | | | | | | |
| MgO | 8.5 | 8.4 | 7.9 | 11.8 | 7.1 | 0 | 10.4 | 9.3 |
| Bauxite | 14.0 | 20.3 | 21.3 | 1.3 | 12.3 | 13.2 | 16.2 | 7.0 |

Each of the blends described in Table 2A was used to prepare substantially round and spherical pellets according to a process using a high intensity mixer, which is similar to a process for making proppant described in U.S. Pat. No. 4,879,181 to Fitzgibbon.

In this Example 1, each blend was fed individually in a batch mode to an Eirich mixer having a circular table that can be horizontal or inclined between 0 and 35 degrees from horizontal, and can rotate at a speed of from about 10 to about 60 revolutions per minute (rpm). The mixer also has a rotatable impacting impeller that can rotate at a tip speed of from about 5 to about 50 meters per second. The direction of rotation of the table is opposite that of the impeller, which causes material added to the mixer to flow over itself in countercurrent manner. The central axis of the impacting impeller is generally located within the mixer at a position off center from the central axis of the rotatable table. For forming the foundry media in this Example 1, the table was rotated at from about 20 to about 40 rpm, at an incline of about 30 degrees from horizontal. The impacting impeller was initially rotated at about 25-35 meters per second (about 1014-1420 rpm), and was adjusted as described below, during addition of water to the mixer.

While the blend was being stirred in the Eirich mixer, water was added to the mixer in an amount sufficient to cause formation of substantially round and spherical pellets. In this particular example, the water was fresh water, which was added to the mixer in an amount sufficient to provide a percentage, based on the weight of the raw material in the mixer, from about 18 to about 22 weight %, although this amount can vary. In general, the quantity of water used in the present methods is that amount which is sufficient to cause substantially round and spherical pellets to form upon mixing. Those of ordinary skill in the art will understand how to determine a suitable amount of water to add to the mixer so that substantially round and spherical pellets are formed.

The rate of water addition to the mixer is not critical. The intense mixing action disperses the water throughout the mixture. During the addition of the first half of the amount of water, the impacting impeller was rotated at about 16 meters per second (about 568 rpm), and was thereafter rotated at a higher tip speed of about 32 meters per second (about 1136 rpm). The initial rotation of the impeller is optional. If employed, the initial rotation can be from about 5 to about 20 meters per second, followed by a higher tip speed in a range of from about 25 to about 35 meters per second. Those of ordinary skill in the art can determine whether to adjust the rotation speed of the impeller and/or pan to values greater than or less than those described in this Example 1 such that substantially round and spherical pellets are formed.

After about 2 to about 6 minutes of mixing, substantially round and spherical pellets are formed. The amount of mixing time can vary depending upon a number of factors, including but not limited to the amount of material in the mixer, speed of operation of the mixer, the amount of water added to the mixer, and the desired pellet size. Those of ordinary skill in the art can determine whether the mixing time should be greater than or less than the times described in this Example 1 such that substantially round and spherical pellets of the desired size are formed. Once the pellets reach the desired size, the rotor is slowed back to about 16 meters per second (about 568 rpm), 10% more of the raw material dust is added (based on dry amount of raw material first added to the mixer), and mixing continues for about a minute. The “trim” dust helps smooth the surface of the pellets. The desired size of the foundry media, after sintering, to be made in this Example 1 is described in Table 1D. To compensate for shrinkage that occurs during sintering, the pellets discharged from the mixer are about 1 to 2 U.S. Mesh sizes larger than the desired size for the sintered product.

The formed pellets were discharged from the mixer and dried. In the present example, the pellets were poured in a stainless steel pan and placed overnight in a drying oven operating at 110° C., resulting in pellets having a moisture content of less than about 1 weight %. The pellets are referred to as “green” after removal from the dryer because they have not been sintered to their final state.

The green pellets formed from each of Blend Nos. 1-8 were placed in alumina boats, which were loaded into a Lindburgh Blue M 1700° C. Box Furnace (Model BF51664PC) operating under the conditions described in Table 2B. “HR” indicates the approximate heating rate of the kiln, in ° C. per hour. “Soak Temp” indicates the approximate peak firing temperature of the kiln, and the “Soak Time” indicates the residence time of the pellets in the kiln at the “Soak Temp”.

TABLE 2B
Sintering Conditions

| | 1 | 2 | 3 | 4 | 5 | 6 | 7 | 8 |
|---|---|---|---|---|---|---|---|---|
| HR (° C./hr) | 960 | 960 | 960 | 960 | 960 | 960 | 960 | 960 |
| Soak Temp | 1360 | 1400 | 1360 | 1400 | 1400 | 1380 | 1400 | 1400 |
| (° C.) | | | | | | | | |
| Soak time | 30 | 30 | 30 | 30 | 30 | 30 | 30 | 30 |
| (min) | | | | | | | | |

The green pellets can be screened prior to sintering such that only pellets of the desired size are placed in the kiln. In addition, the sintered pellets can be screened upon removal from the kiln. Methods and equipment screening and similar separation by size are known to those of ordinary skill in the art.

Various properties of the sintered pellets prepared from each blend were evaluated. The results are reported in Table 2C. A result reported as “n/a” indicates that the property was not determined.

TABLE 2C
Properties of Sintered Pellets

| | 1 | 2 | 3 | 4 | 5 | 6 | 7 | 8 |
|---|---|---|---|---|---|---|---|---|
| Targeted | −30/+50 | −20/+40 | −30/+50 | −30/+50 | −30/+50 | −20/+40 | −50/+140 | −50/+140 |
| Size after | 600μ-300μ | 850μ-425μ | 600μ-300μ | 600μ-300μ | 600μ-300μ | 850μ-425μ | 300μ-106μ | 300μ-106μ |
| Sintering | | | | | | | | |
| U.S. Mesh | | | | | | | | |
| and | | | | | | | | |
| Micron | | | | | | | | |
| Equivalent | | | | | | | | |
| Determined | n/a | n/a | n/a | n/a | n/a | n/a | 77.3 | 57.6 |
| GFN | | | | | | | | |
| ASG | 2.45 | 2.58 | 2.54 | 2.48 | 2.54 | 2.39 | 2.60 | 2.58 |
| Whole Pellet | 2.6826 | 2.7221 | 2.7013 | 2.5678 | 2.6479 | 2.7009 | 2.6798 | 2.6325 |
| SG (g/cc) | | | | | | | | |
| Ground | 2.7935 | 2.8400 | 2.8335 | 2.7492 | 2.7859 | 2.7864 | 2.8641 | 2.7382 |
| Pellet | | | | | | | | |
| SG (g/cc) | | | | | | | | |
| Internal | 4.0 | 4.2 | 4.7 | 6.6 | 5.0 | 3.1 | 6.4 | 3.9 |
| Porosity (%) | | | | | | | | |
| BD (g/cc) | 1.25 | 1.35 | 1.28 | 1.32 | 1.32 | 1.21 | 1.31 | 1.28 |
| 4 Kpsi Crush | 8.4 | 4.8 | 4.4 | 7.7 | 5.8 | 8.0 | 4.0 | 1.6 |
| (%) | | | | | | | | |
| MIP Porosity | 6.0 | 3.2 | 3.2 | 2.9 | 2.8 | 11.9 | 2.2 | 0.5 |
| (%) | | | | | | | | |
| MgO | 14.64 | 14.71 | 13.99 | 12.1 | 13.17 | 12.94 | 13.5 | 12.4 |
| (ICP - wt %) | | | | | | | | |
| Al₂O₃ | 41.5 | 43.72 | 44.58 | 43.89 | 42.07 | 41.24 | 44.8 | 42.0 |
| (ICP - wt %) | | | | | | | | |
| SiO₂ | 38.55 | 35.93 | 36.05 | 40.22 | 39.78 | 39.53 | 37.1 | 41.4 |
| (ICP - wt %) | | | | | | | | |
| Cordierite | 61.1 | 55.3 | 52.9 | 62.5 | 62.9 | 63.3 | 58.9 | 65.1 |
| (XRD - wt %) | | | | | | | | |
| Mullite | 7.7 | 11.6 | 16.6 | 23.2 | 12.9 | 19 | 15.4 | 19.9 |
| (XRD - | | | | | | | | |
| wt %) | | | | | | | | |
| Sapphirine | 5.9 | 7.2 | 6.8 | 2.4 | 4.2 | 3.5 | 5.7 | 1.6 |
| (XRD - | | | | | | | | |
| wt %) | | | | | | | | |
| Cristobalite | 0.2 | 0 | 0.1 | 0.2 | 0.2 | 0 | 0 | 0.1 |
| (XRD - wt %) | | | | | | | | |
| Glass | 25.1 | 25.9 | 23.6 | 11.7 | 19.9 | 14.3 | 20.0 | 13.3 |
| (XRD - | | | | | | | | |
| wt %) | | | | | | | | |
| CTE from | 3.5 | 3.8 | 3.8 | 3.2 | 3.6 | 3.1 | 3.6 | 2.5 |
| 100-1100° C. | | | | | | | | |
| (10⁻⁶ in/ | | | | | | | | |
| in ° C.) | | | | | | | | |

The targeted size reported in Table 2C is approximately the desired pellet size for this Example 1, after shrinkage due to sintering. After sintering, a sample of the sintered pellets can be screened in a laboratory for separation by size, for example, intermediate sizes between 20, 30, 40, 50, 70, 100, 140, 200, and 270 U.S. mesh sizes. The measured size distribution can be used to calculate a grain fineness number (GFN). The correlation between sieve size and GFN can be determined according to Procedure 106-87-S of the American Foundry Society Mold and Core Test Handbook, which is known to those of ordinary skill in the art.

The reported apparent specific gravity (ASG) of the sintered pellets is a number without units, and is numerically equal to the weight in grams per cubic centimeter of volume, excluding void space or open porosity in determining the volume, divided by the density of water (approximately 1 g/cc). The ASG values given herein were determined by the Archimedes method of liquid (water) displacement according to API Recommended Practices RP60 for testing proppants, which is a text known and available to those of ordinary skill in the art.

The whole pellet specific gravity (SG) reported in Table 2C indicates the density of the pellets, including closed porosity, and was determined with a Micromeritics brand helium gas pycnometer, operated according to the procedures of the manufacturer.

The ground pellet SG was determined by grinding the pellets to a fine dust, and then using the aforementioned Micromeritics brand helium gas pycnometer to determine the SG of the dust. The ground pellet SG indicates the density without any pores.

Internal porosity indicates the amount of internal (closed) porosity in the pellet. The percent internal porosity reported in Table 2C was calculated from the difference between the SG of the whole pellets and the SG of the ground pellets divided by the SG of the ground pellets.

The bulk density reported in Table 2C includes the void spaces between the pellets as a part of the volume, and was determined by ANSI Test Method B74.4-1992 (R 2002), which is a text known and available to those of ordinary skill in the art.

The crush of the sintered pellets is expressed as a weight percent of fines (i.e., material less than 140 mesh for materials with a GFN of 60 and higher) per 4000 psi. The crush values reported in Table 2C were determined according to API Recommended Practices RP60 for testing proppants, which is a text known to those of ordinary skill in the art.

The MIP porosity indicates the surface porosity of the pellets, and was measured with a Micromeritics brand mercury intrusion porosimeter (MIP). This MIP uses high pressure to “inject” mercury into the pores on the surface of pellets, and then measures how much mercury is injected from atmospheric pressure to 30,000 psia. The percent surface porosity is calculated based on the weight of sample and the amount of mercury injected into the pellets from 30 to 30,000 psia.

The weight percents of magnesia, alumina and silica reported in Table 2C were determined by inductively coupled plasma-optical emission spectra (ICP or ICP-OES), according to methods known to those of ordinary skill in the art.

The weight percents of cordierite, mullite, sapphirine, cristobalite and glass in the sintered pellets were determined by x-ray diffraction (XRD), which is an analytical method known to those of ordinary skill in the art. It can be seen from Table 2C that compositions that include from about 12 to about 15 weight percent of magnesia, from about 41 to about 45 weight percent alumina and from about 35 to about 42 weight percent silica can be used to produce material suitable for use as foundry media having from about 52 to about 66 weight percent cordierite, from about 7 to about 24 weight percent mullite and from about 1 to about 8 weight percent sapphirine.

The coefficient of thermal expansion (CTE) reported in Table 2C indicates the change in length of a line segment in the pellets, per unit of temperature change, over the reported temperature range of from 100° C. to 1100° C. For testing the thermal expansion of pellets, the pellets were ground to less than 200 microns in size. A binder-water mixture was formed by mixing water and a methylcellulose binder commercially available from Dow Chemical under the tradename of Methocel F. The binder was included in an amount of about 2.5 wt % of the total weight of the binder-water mixture. The binder-water mixture was then mixed with the powder to form a granulated powder. The binder-water mixture was mixed with the powder in an amount of about 10 to about 15 weight percent of the total weight of the granulated powder. The granulated powder was then dried until about 5 to about 7 weight percent of water remained. The dried powder was pressed into bars 1 inch in length, and the bars were dried for about 24 hours at about 220° F. Following the procedures set forth in ASTM E 228-85, the thermal expansion of the bars was measured as a function of temperature using an Orton Dilatometer Model 1600D (The Edward Orton Jr. Ceramic Foundation—Thermal Instrument Unit) which is a push rod dilatometer. The dilatometer was calibrated with a NIST traceable platinum standard according to a method known to those of ordinary skill in the art. The expansion was measured while the sample was heated from room temperature to 1400° C., cooled back to room temperature and reheated to 1400° C. The heating and cooling rate was 3° C. per minute. The CTE was calculated from the second heating cycle as the change in length per change in temperature over the range of 100° C. to 1100° C.

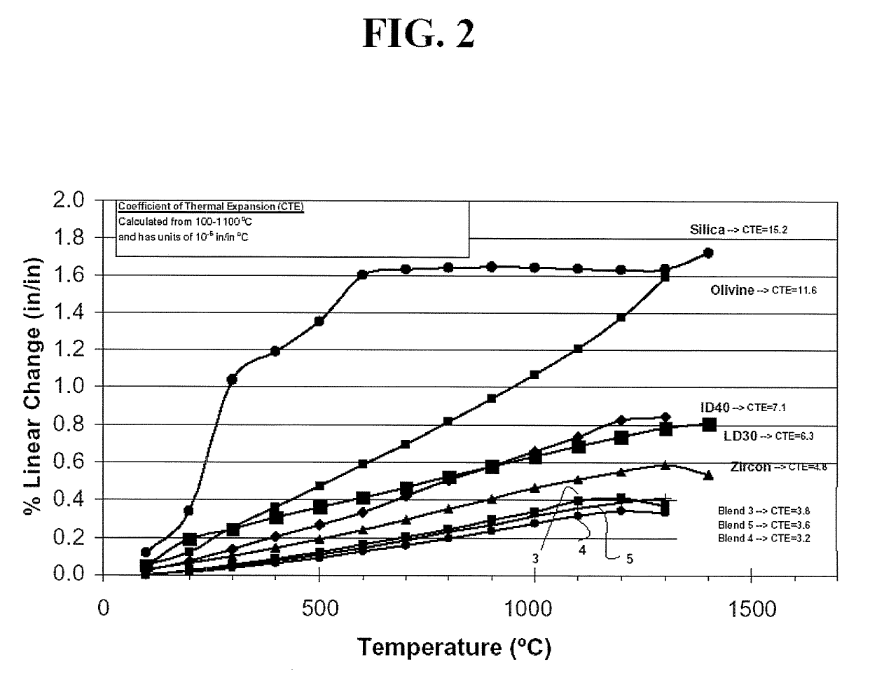

FIG. 2 illustrates a comparison of (a) the manufacturer-published percent of linear change as a function of temperature and the calculated CTEs of a foundry media commercially available from CARBO Ceramics under the tradenames ACCUCAST® ID40 and ACCUCAST® LD 30; (b) the percent of linear change as a function of temperature and calculated CTEs of silica sand, zircon sand, and olivine sand; and (c) the percent of linear change as a function of temperature and calculated CTEs of pellets formed from Blend Nos. 3, 4 and 5, each of which is reported from 100-1100° C. The CTEs and percent linear changes of the pellets formed from Blend Nos. 3, 4 and 5, silica sand, zircon sand and olivine sand were determined by dilatometry as described above.

As illustrated in FIG. 2, from 100-1100° C., CTEs of pellets formed from Blend Nos. 3, 4 and 5 are lower than those determined for silica sand, zircon sand, and olivine sand, and the manufacturer-published CTEs of ACCUCAST® ID40 and ACCUCAST® LD 30 foundry media. Specifically, Blend No. 4 has a CTE, from 100-1100° C., that is 79%, 33%, 72%, 55% and 49% less than that of silica sand, zircon sand, olivine sand, ACCUCAST® ID40 foundry media and ACCUCAST® LD 30 foundry media, respectively. As reported in Table 2C, from 100-1100° C., the CTEs of pellets formed from Blend Nos. 1, 2 and 6-8 are also lower than those of silica sand, olivine sand, zircon sand, and the ACCUCAST® foundry media. The reported crush and low density of pellets formed from Blend Nos. 1-8 each individually demonstrate suitability of the blends for forming foundry media. The low crush values together with the low thermal expansion will allow for the material to be “recycled” (i.e. used for multiple castings instead of used for a single casting and discarded for landfill.) The low density of approximately 2.5 (ASG) would allow for lighter weight molds and use of less resin compared to molds made from zircon sand which has a density of approximately 4.6 (ASG).

### EXAMPLE 2

### Pellets

Three blends were prepared with raw materials as described in Table 1, in the weight percents reported in Table 3A. The bauxite and kaolin were calcined prior to mixing with the other raw materials at times and temperatures sufficient to substantially remove organic material and water of hydration. The other raw materials were uncalcined.

As indicated in Table 3A, Kaolin M was used for all three blends, and Talc A was used for Blend Nos. 9 and 10. Raw materials of the types and amounts (in weight percents) reported in Table 3A were fed to an Eirich mixer, which is described in Example 1. The raw materials were blended together by the mixing action of the Eirich mixer. Once the raw materials were blended into a substantially homogenous batch, the batch was removed from the mixer, and about 10% by weight was set aside to provide a trim dust for pellets to be formed in the mixer. The remainder of the batch was returned to the mixer, and then water was aided to form substantially round and spherical green pellets in the manner as described in Example 1. The trim dust was added after the green pellets had reached a size approximately large enough, based on visual observation, to compensate for shrinkage (about 1 to 2 U.S. Mesh sizes) that occurs on sintering.

TABLE 3A
Blends of Raw Materials

| | 9 | 10 | 11 |
|---|---|---|---|
| Kaolin | 80.6 (M) | 56.9 (M) | 87.3 (M) |
| Talc | 14.6 (A) | 15.0 (A) | 0 |
| Olivine Sand | 0 | 0 | 0 |
| MgO | 4.9 | 7.4 | 11.9 |
| Bauxite | 0 | 20.6 | 0.8 |

The green pellets discharged from the Eirich mixer were dried as described in Example 1, and then sintered in a box kiln operating under the conditions described in Table 3B.

TABLE 3B
Sintering Conditions

| | 9 | 10 | 11 |
|---|---|---|---|
| HR (° C./hr) | 960 | 960 | 960 |
| Soak Temp (° C.) | 1400 | 1400 | 1420 |
| Soak time (min) | 30 | 30 | 30 |

The green pellets can be screened prior to sintering such that only pellets of the desired size are fed to the kiln. In addition, the sintered pellets can be screened upon discharge from the kiln. Methods and equipment for screening and similar separation by size are known to those of ordinary skill in the art.

Various properties of the sintered pellets prepared from each blend were evaluated. The results are reported in Table 3C. It can be seen from Table 3C that compositions that include from about 13 to about 14 weight percent of magnesia, from about 40 to about 45 weight percent alumina and from about 36 to about 43 weight percent silica can be used to produce material suitable for use as foundry media having from about 25 to about 42 weight percent cordierite, from about 19 to about 21 weight percent mullite and from about 7 to about 11 weight percent sapphirine.

TABLE 3C
Properties of Sintered Pellets

| | 9 | 10 | 11 |
|---|---|---|---|
| Targeted Size after Sintering | −30/+50 | −30/+50 | −30/+50 |
| U.S. Mesh | 600μ-300μ | 600μ-300μ | 600μ-300μ |
| and Micron Equivalent | | | |
| ASG | 2.20 | 2.54 | 2.63 |
| BD (g/cc) | 1.13 | 1.25 | 1.30 |
| 4 Kpsi Crush (%) | 35.5 | 27.8 | 17.5 |
| MIP Porosity (%) | 3.7 | N/A | N/A |
| MgO (wt %) | 11.4 | 13.7 | 13.5 |
| SiO₂ (wt %) | 48.0 | 36.2 | 42.7 |
| Al₂O₃ (wt %) | 36.8 | 44.6 | 40.6 |
| Cordierite (XRD wt %) | 63.6 | 41.8 | 25.9 |
| Mullite (XRD wt %) | 19.9 | 20.5 | 19.9 |
| Sapphirine(XRD wt %) | 0 | 7.1 | 10.8 |
| Cristobalite (XRD wt %) | 7.2 | 0 | 0 |
| Glass (XRD wt %) | 9.3 | 30.5 | 43.3 |
| CTE from 100-1100° C. | 2.8 | 4.0 | 3.2 |
| (10⁻⁶ in/in ° C.) | | | |

The targeted size reported in Table 3C is approximately the desired pellet size for this Example 2, after shrinkage due to sintering. The properties reported in Table 3C were determined in the manner as described in Example 1. Of the three blends, Blend No. 11 contained the least amount of cordierite and the most amount of glass. The low amount of cordierite is likely due at least in part to the presence of other oxides in small amounts from impurities in the magnesia, alumina and silica sources of Blend No. 11, and the effect of the higher sintering temperature on the raw materials used for Blend No. 11. Regardless, however, the raw materials used for Blend No. 11 produced a net chemistry Such that it did form cordierite in an amount sufficient to produce a foundry media having a low CTE as described herein.

The CTE of pellets formed from each blend is lower than the CTE for silica sand, olivine sand, and zircon sand reported in FIG. 2. Thus, the blends of this Example 2 are well-suited for use as foundry media. Moreover, the low density of such foundry media, approximately 2.5 (ASG), would allow for lighter weight molds and molds requiring less resin, as compared to molds made from zircon sand which has a density of approximately 4.6 (ASG).

### EXAMPLE 3

### Bars

Five blends were prepared with raw materials as described in Table 1, in the weight percents reported in Table 4A. The bauxite and kaolin were calcined prior to mixing with the other raw materials at times and temperatures to remove organic material and substantially remove water of hydration. The other raw materials were uncalcined.

As indicated in Table 4A, Kaolin M was used for all five blends, and Talc C was used for Blend Nos. 12 and 13. Raw materials of the types and amounts (in weight percents) reported in Table 4A were processed into 3″×⅜″×˜⅜″ bars by pressing a blend of the raw materials at 12.5 Kpsi using a conventional uniaxial press device well know to those of ordinary skill in the art.

TABLE 4A
Blends of Raw Materials

| | 12 | 13 | 14 | 15 | 16 |
|---|---|---|---|---|---|
| Kaolin | 82.9 (M) | 86.7 (M) | 84.6 (M) | 77.9 (M) | 87.5 (M) |
| Talc | 15.1 (C) | 5.9 (C) | 0 | 0 | 0 |
| Olivine | 0 | 0 | 0 | 0 | 0 |
| Sand | | | | | |
| MgO | 3.8 | 7.8 | 13.2 | 12.7 | 11.7 |
| Bauxite | 0 | 0 | 2.3 | 10.4 | 0.8 |

The bars were then sintered in a box kiln operating under the conditions described in Table 4B.

TABLE 4B
Sintering Conditions

| | 12 | 13 | 14 | 15 | 16 |
|---|---|---|---|---|---|
| HR (° C./hr) | 480 | 480 | 480 | 480 | 480 |
| Soak Temp (° C.) | 1400 | 1400 | 1400 | 1400 | 1400 |
| Soak Time (min) | 60 | 60 | 60 | 60 | 60 |

The CTE of the sintered bars prepared from each blend was evaluated, and the results are reported in Table 4C. The properties (other than ASG) reported in Table 4C were determined in the manner as described in Example 1. The ASG was measured by Archimedes method following the manufacturer's procedure for a Fisher ACCU-224 0.1 mg Balance with Density Kit. It can be seen from Table 4C that compositions that include from about 10 to about 14 weight percent of magnesia, from about 39 to about 44 weight percent alumina and from about 38 to about 47 weight percent silica can be used to produce material suitable for use as foundry media having from about 80 to about 90 weight percent cordierite, from about 3 to about 10 weight percent mullite and from about 0 to about 16 weight percent sapphirine.

TABLE 4C
CTE of Sintered Bars

| | 12 | 13 | 14 | 15 | 16 |
|---|---|---|---|---|---|
| ASG | 2.41 | 2.40 | 2.51 | 2.60 | 2.44 |
| MgO | 9.5 | 10.2 | 14.1 | 13.7 | 12.8 |
| (ICP - wt %) | | | | | |
| SiO₂ | 50.5 | 47.0 | 42.6 | 38.9 | 43.9 |
| (ICP - wt %) | | | | | |
| Al₂O₃ | 37.6 | 39.7 | 40.4 | 43.8 | 40.6 |
| (ICP - wt %) | | | | | |
| Cordierite | 82.3 | 80.8 | 81.6 | 81.6 | 89.5 |
| (XRD - wt %) | | | | | |
| Mullite | 12.5 | 9.1 | 3.1 | 5.1 | 5.3 |
| (XRD - wt %) | | | | | |
| Sapphirine | 0 | 0 | 15.3 | 13.3 | 5.3 |
| (XRD - wt %) | | | | | |
| Cristobalite | 5.2 | 0 | 0 | 0 | 0 |
| (XRD - wt %) | | | | | |
| Glass | 0 | 10.1 | 0 | 0 | 0 |
| (XRD - wt %) | | | | | |
| CTE from | 2.3 | 2.3 | 2.7 | 3.1 | 2.5 |
| 100-1100° C. | | | | | |
| (10⁻⁶ in/ | | | | | |
| in ° C.) | | | | | |

The higher amount of cordierite formed in the bars of this Example 3 may be due in part to the slower ramp rate of the sintering conditions of the bars as compared to that of the pellets of Examples 1 and 2 (480° C./hr for the bars and 960° C./hr for the pellets). Slower ramp rates, however, add to the time it takes to produce finished sintered pellets. Accordingly, the ramp rate can be adjusted to that amount that will produce sintered pellets having the desired properties in the desired amount of time.

The CTE of bars formed from each blend is lower than the CTE for silica sand, olivine sand and zircon sand reported in FIG. 2. Thus, the blends of this Example 3 are suitable for further processing into foundry media having a low expansion property. For example, the blends of this Example 3 can be pelletized according to any of the methods described in any of Examples 1 and 2 above, or the alternative embodiments below.

### EXAMPLE 4

### Metal Castings Made from Pellets

One blend referred to as Blend 17 was prepared with raw materials as described in Table 5A, in the weight percents reported in Table 5B. The kaolin was calcined prior to mixing with the other raw materials at times and temperatures sufficient to substantially remove organic material and water of hydration. The other raw materials were uncalcined.

TABLE 5A
Chemical Analysis of Raw Materials (wt. %) - Blend 17

| | MgO | Al₂O₃ | SiO₂ | CaO | Na₂O | K₂O | TiO₂ | Fe₂O₃ | Other | LOI |
|---|---|---|---|---|---|---|---|---|---|---|
| Kaolin C2 | 0.06 | 49.26 | 47.20 | 0.03 | 0.03 | 0.09 | 2.23 | 0.96 | 0.14 | 2.19 |
| Talc B2 | 33.97 | 0.34 | 62.24 | 3.07 | — | 0.12 | 0.03 | 0.22 | 0.01 | 10.54 |
| MgO | 98.64 | 0.08 | 0.28 | 0.83 | — | — | — | 0.17 | — | 1.25 |

Kaolin C2 was obtained from the same source as “Kaolin C” shown in Table 1 but was taken from a different lot of material. Similarly Talc B2 was obtained from the same source as “Talc B” shown in Table 1 but was taken from a different lot of material. The magnesia shown in Table 5A is from the same source and lot of material shown in Table 1. As indicated in Table 5B, Kaolin C2 and Talc B2 were used for Blend 17. Raw materials of the types and amounts (in weight percents) reported in Table 5B were fed into a 10 cu-ft double ribbon blender. After the raw materials were blended together by the mixing action of the ribbon blender they were fed into a Jet Mill (Netzsch CONDUX® Fluidized Bed Jet Mill model CGS 16). The ground batch had an average particle size of less than 4 microns and 99.9% was less than 14 microns in size. The majority of the batch was placed in an Eirich mixer, and then water was added to form substantially round and spherical green pellets in the manner as described in Example 1. Trim dust was added similar to the process of Example 1 after the green pellets had reached a size approximately large enough, based on visual observation, to compensate for shrinkage (about 1 to 2 U.S. Mesh sizes) that occurs on sintering.

TABLE 5B
Blend of Raw Materials - Blend 17

| Kaolin | 81.70 (C2) |
|---|---|
| Talc | 9.54 (B2) |
| MgO | 8.76 |

The green pellets discharged from the Eirich mixer were dried as described in Example 1, placed in alumina boats and then sintered in a Lindburgh Blue box kiln M 1700° C. Box Furnace (Model BF51664PC) operating under the conditions described in Table 5C.

TABLE 5C
Sintering Conditions

| | |
|---|---|
| HR (° C./hr) | 960 |
| Soak Temp (° C.) | 1420 |
| Soak time (min) | 30 |

The green pellets can be screened prior to sintering such that only pellets of a desired size are fed to the kiln. In addition, the sintered pellets can be screened upon discharge from the kiln. Methods and equipment for screening and similar separation by size are known to those of ordinary skill in the art.

Various properties of the sintered pellets prepared from the blend shown in Table 5B were evaluated. The results are reported in Table 5D.

TABLE 5D
Properties of Sintered Pellets

| Size after Sintering U.S. Mesh and | 58 GFN |
|---|---|
| Micron Equivalent | −40/+140 mesh |
| | 420μ-105μ |
| ASG | 2.40 |
| BD (g/cc) | 1.24 |
| 4 Kpsi Crush (%) | N/A |
| MIP Porosity (%) | 2.4 |
| MgO (wt %) | 12.4 |
| SiO₂ (wt %) | 45.6 |
| Al₂O₃ (wt %) | 42.0 |
| Cordierite (XRD wt %) | 70.8 |
| Mullite (XRD wt %) | 19.6 |
| Sapphirine(XRD wt %) | 0.4 |
| Cristobalite (XRD wt %) | 0 |
| Glass (XRD wt %) | 9.3 |
| CTE from 100-1100° C. (10⁻⁶ in/in ° C.) | 2.2 |

The targeted size reported in Table 5D is approximately the desired pellet size for this Example 4, after shrinkage due to sintering. The properties reported in Table 5D were determined in the manner as described in Example 1.

The CTE of pellets formed from the blend shown in Table 5B is lower than the CTE for silica sand, olivine sand, and zircon sand reported in FIG. 2. Thus, Blend 17 of this Example 4 is well-suited for use as foundry media which was demonstrated by actual step cone castings as described below.

Step cones were cast using the sintered pellets as a core for the casting. Step cones are known to those of ordinary skill in the art to be useful as a test for evaluating defects in castings. The step cone casting used had a cylinder shape approximately 7 inches (17.8 cm) tall and 5 inches (12.7 cm) in diameter. The core formed six inner “rings” which are approximately an inch tall and have a decreasing inner diameter ranging from 4 inches (10.2 cm) down to 1.5 inches (3.8 cm) in 0.5 inch increments (1.3 cm).

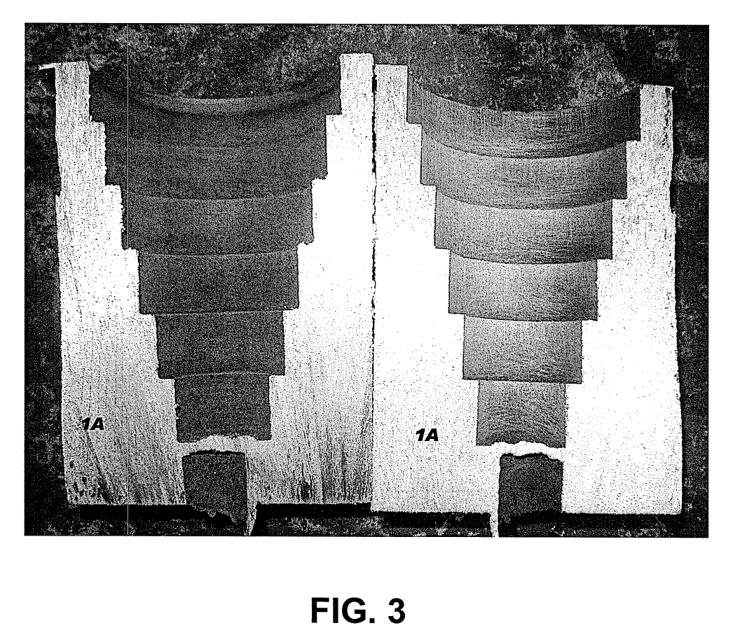

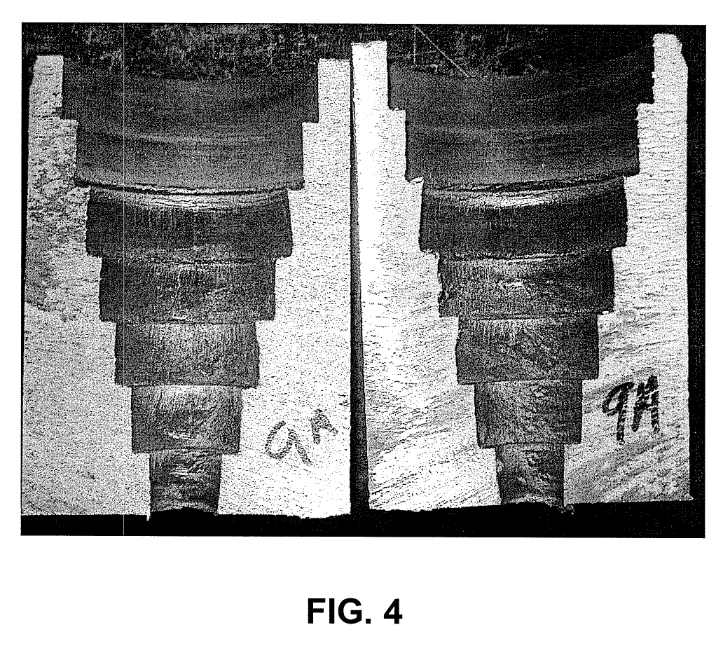

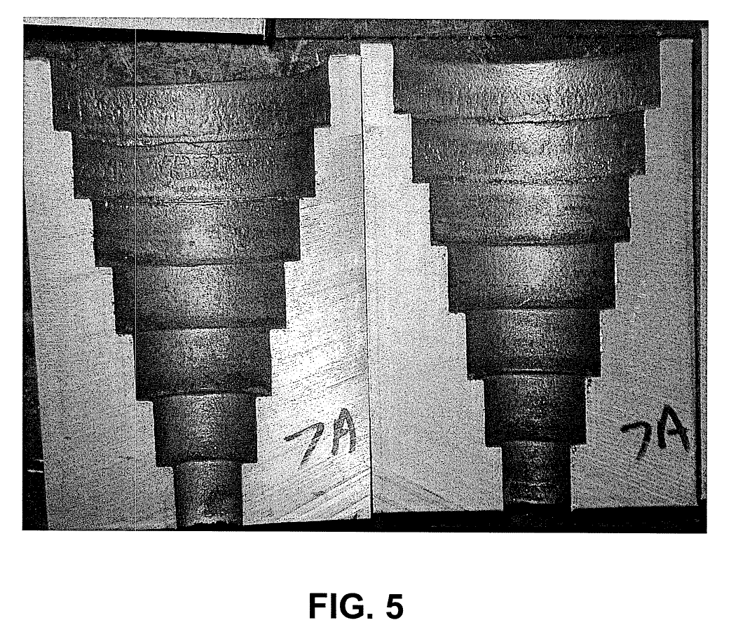

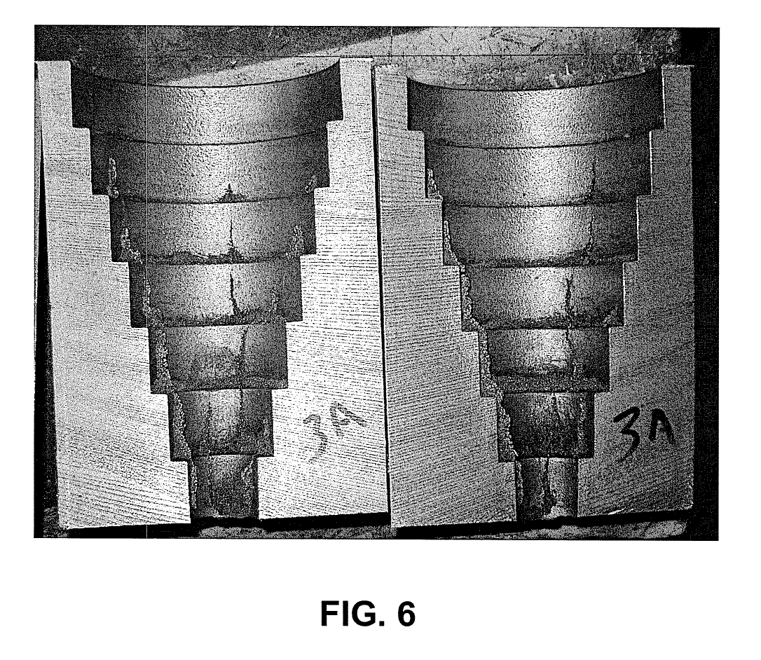

Step cone cores were produced from the sintered pellets using a phenolic urethane cold box binder (H.A. International's Sigma Cure 305/705) at a level of 2.5% by weight of sintered pellets. A quantity of sintered pellets were weighed and placed in a 5 quart (4.7 liter) stainless steel mixing bowl of a KitchenAid Tilt Head Stand Mixer. The required quantity of binder was weighed and added to pellets in the mixing bowl. The binder was added to a pocket produced in the pellets and covered prior to mixing to assure that the binder did not adhere to the blending paddles. The contents were mixed for a total of two minutes and were flipped twice with a flipping motion of the bowl to assure proper blending of all the contents and to avoid leaving any dry unblended additives on the bottom of the mixing bowl. The contents were then transferred to a step cone core box where it was compacted by a ramming procedure that is well known to those of ordinary skill in the art. The step cone core box was then placed in the gassing chamber of a Gaylord Gas Generator and gassed for 4 seconds using triethylamine (TEA) at a pressure of 20 psi (139 kPa) and then purged for 45 seconds using dry air at a pressure of 40 psi (276 kPa). Some of the step cone cores were dip coated in either graphite or a zircon wash. Step cones were cast in aluminum and grey iron. Aluminum castings were cast in A356 aluminum at a temperature of 649° C. (1200° F.). The iron castings were cast in a class 30 grey iron with a nominal composition of 3.20% carbon and 2.20% silicon at a temperature of 1427° C. (2600° F.). Castings were sectioned and adhering sand removed by the use of a wire brush. FIGS. 3 and 4 show sections of aluminum step cones produced from cores made from sintered pellets made from the blend shown in Table 5B and having the properties shown in Table 5D and zircon sand, respectively, which illustrate the improvement in the casting from such pellets compared to zircon sand. FIGS. 5 and 6 show sections of grey iron step cones produced from cores made from sintered pellets made from the blend shown in Table 5B and having the properties shown in Table 5D and silica sand, respectively, which illustrate the marked improvement in the casting from such pellets compared to silica sand.

### Alternative Embodiment

Using the methods exemplified herein, it is possible to predict blends of raw materials that would provide a net chemistry such that, when pellets formed from such raw materials are sintered, the sintered pellets have CTEs, from about 100 to about 1100° C., less than that of zircon sand (reported herein as 4.8 (10⁻⁶ in/in ° C.)), with cordierite levels as low as about 7 percent by weight. According to such an embodiment, attaining a CTE of about 4.7 (10⁻⁶ in/in ° C.), from about 100 to about 1100° C., is set as a constant.

Cordierite-Mullite-Sapphirine Embodiment

In some such embodiments, the net chemistry of the raw materials is targeted to fall in the cordierite-mullite-sapphirine region of a magnesia-alumina-silica phase diagram. It can be expected that some amount of glass, mullite, sapphirine and cordierite will form. The amounts of glass, mullite, sapphirine and cordierite expected to result in a CTE, from about 100 to about 1100° C., of about 4.7 (10⁻⁶ in/in ° C.) were determined using the data reported in Table 6A and the following calculations.

The expansion of mullite and sapphirine are in the same basic range (mullite is a little lower), so the relative amounts of mullite and sapphirine formed in the sintered pellets can vary without significant changes in the calculation of CTE. Thus, for purposes of simplifying the calculations, it was assumed that equal amounts of mullite and sapphirine (e.g. 41.5 wt. % as repotted for Composition A in Table 6A) are formed in the sintered pellets. It was also assumed that at least some amount of glass will form upon sintering, as was the case with most of the blends in Examples 2-4 herein. Using the results presented herein as a guide, it was assumed that glass will form in amounts of about 10, 20, 25 or 30 weight percent (Table 6A). Finally, the amount of cordierite expected to form was calculated by using multiplication factors of the weight percents of glass, mullite and sapphirine by their respective CTEs, and solving for what weight percent of cordierite, multiplied by its CTE, would result in the desired constant of about 4.7 (10⁻⁶ in/in ° C.) from 100 to 1100° C.

For these calculations, CTE values, from 100 to 1100° C., for glass, mullite, sapphirine, cristobalite and cordierite were estimated by compiling and averaging published values taken from (a) Introduction to Ceramics, 2^{nd} Edition, John Wiley & Sons, Edited by W. D. Kingery, H. K. Bowen, and D. R. Uhlmann (1976), and (b) Engineered Materials Handbook, Volume 4: Ceramics and Glass, ASM International, Edited by S. J. Scheider (1991). The estimations resulted in the following CTE values (100-1100°, 10⁻⁶ in/in ° C.): glass—7.5; mullite—4.5; sapphirine—4.8; cristobalite—15.2; cordierite—2.0.

As reported in Table 6A, the amount of cordierite that could result in a CTE of about 4.7 (10⁻⁶ in/in ° C.), from 100 to 1100° C., is as low as 7 weight percent. Thus as reported in Table 6A, the desired CTE can be achieved by compositions that include from about 5 to about 30 weight percent cordierite.

TABLE 6A

| | | | | | Theoretical |
|---|---|---|---|---|---|
| | | | | | CTE from |
| | Glass | Mullite | Sapphirine | Cordierite | 100-1100° C. |
| Composition | wt. % | wt. % | wt. % | wt. % | (10⁻⁶ in/in ° C.) |
| A | 10 | 41.5 | 41.5 | 7 | 4.7 |
| B | 20 | 31 | 31 | 18 | 4.7 |
| C | 25 | 25.5 | 25.5 | 24 | 4.7 |
| D | 30 | 20.5 | 20.5 | 29 | 4.7 |

Also using the methods described herein as a guide, blends of raw materials that would result in the phases reported in Table 6A can be estimated.

Kaolin Type C, magnesia and bauxite having the chemical analysis reported in Table 1 were selected as the raw materials for this embodiment, although any of the raw materials described herein would be suitable. To estimate the amount of each of the raw materials that would need to be present in a blend to produce blends having the phases reported in Table 6A, the net magnesia, alumina and silica contents of each of the compositions described in Table 6A were calculated by multiplying the amounts of each of glass, mullite, sapphirine and cordierite present with the chemical formula of each. For glass, the chemical formula was estimated to be about 21.8% magnesia, about 33.1% alumina and about 45.1% silica, which estimate was made based on average values of magnesia, alumina and silica found in the glass formed in the pellets of Examples 1 and 2.

Using the calculations described above, it was determined that the net magnesia, alumina and silica contents of the four compositions reported in Table 6A would be from about 11% about 15% by weight magnesia, from about 47% to about 63% by weight alumina, and from about 26% to about 38% by weight silica. With the net magnesia, alumina and silica contents of the four compositions described in Table 6A so calculated, and the magnesia, alumina and silica contents for each of Kaolin Type C, MgO and bauxite known as reported in Table 1, the weight percents of each of Kaolin Type C, MgO and bauxite that would result in the calculated net magnesia, alumina and silica contents were calculated. The results of these final calculations are reported in Table 6B.

TABLE 6B

| Blend | Kaolin Type C wt. % | MgO wt. % | Bauxite wt. % |
|---|---|---|---|
| 18 | 40.9 | 11.0 | 48.3 |
| 19 | 53.9 | 12.6 | 33.5 |
| 20 | 60.6 | 13.5 | 25.9 |
| 21 | 67.3 | 14.2 | 18.5 |

Cordierite-Mullite-Cristobalite Embodiment

In other such embodiments, the net chemistry of the raw materials is targeted to fall in the cordierite-mullite-cristobalite region of a magnesia-alumina-silica phase diagram. As discussed above with respect to a cordierite-mullite-cristobalite embodiment, it can be expected that some amount of glass, mullite, cristobalite and cordierite will form. The amounts of glass, mullite cristobalite and cordierite expected to result in a CTE of about 4.7 (10⁻⁶ in/in ° C.), from about 100 to about 1100° C., were determined using the data reported in Table 6C and the following calculations.

As discussed above, attaining a CTE of about 4.7 (10⁻⁶ in/in ° C.), from about 100 to about 1100° C., was set as a constant and it was assumed that glass would form in an amount of from about 10 to about 30 percent by weight.

As reported in Table 6C, in compositions E-H, it was assumed that mullite and cristobalite would form in equal amounts. Using the weight percents and CTEs of glass, mullite and cristobalite, and the CTE of cordierite in calculations as described above, the equation was solved for the weight percent of cordierite that would result in the desired CTE constant. The calculated amounts of cordierite are reported in Table 6C.

Unlike mullite and sapphirine, however, mullite and cristobalite have dissimilar CTEs (cristobalite expansion is much higher). Thus, according to compositions I-K reported in Table 6C, the amount of cristobalite was assumed to be 10 percent by weight, and the amount of mullite was estimated at 35, 13 and 2 weight percent respectively. Using the weight percents and CTEs of glass, mullite and cristobalite, and the CTE of cordierite in calculations as described above, the equation was solved for the weight percent of cordierite that would result in the desired CTE constant. The calculated amounts of cordierite are reported in Table 6C. As reported in Table 6C, the desired CTE can be achieved by compositions that include from about 45 to about 65 weight percent cordierite.

TABLE 6C

| | | | | | Theoretical |
|---|---|---|---|---|---|
| | | | | | CTE from |
| | | | | | 100-1100° C. |
| | Glass | Mullite | Cristobalite | Cordierite | (10⁻⁶ in/ |
| Composition | wt. % | wt. % | wt. % | wt. % | in ° C.) |
| E | 10 | 14 | 14 | 62 | 4.7 |
| F | 20 | 10.5 | 10.5 | 59 | 4.7 |
| G | 25 | 8.5 | 8.5 | 58 | 4.7 |
| H | 30 | 7 | 7 | 56 | 4.7 |
| I | 10 | 35 | 10 | 45 | 4.7 |
| J | 20 | 13 | 10 | 57 | 4.7 |
| K | 25 | 2 | 10 | 63 | 4.7 |

Also using the methods described herein as a guide, blends of raw materials that would result in the phases reported in Table 6C can be estimated.

Kaolin Type C, Talc Type B, magnesia and bauxite having the chemical analysis reported in Table 1 were selected as the raw materials for Blends 22-28, although any of the raw materials described herein would be suitable. To estimate the amount of each of the raw materials that would need to be present in a blend to produce compositions having the phases reported in Table 6C, the net magnesia, alumina and silica contents of each of the seven compositions described in Table 6C were calculated by multiplying the amounts of each of glass, mullite, sapphirine and cordierite present with the chemical formula of each. For glass, the chemical formula was estimated to be about 21.8% magnesia, about 33.1% alumina and about 45.1% silica, which estimate was made based on average values of magnesia, alumina and silica found in the glass formed in the pellets of Examples 1 and 2.

Using the calculations described above, it was determined that the net magnesia, alumina a and silica contents of the seven compositions reported in Table 6C would be from about 10% to about 17% by weight magnesia, from about 38% to about 51% by weight alumina, and from about 39% to about 46% by weight silica. With the net magnesia, alumina and silica contents of the seven compositions described in Table 6C so calculated, and the magnesia, alumina and silica contents for each of Kaolin Type C, Talc Type B, magnesia and bauxite known as reported in Table 1, the weight percents of each of Kaolin Type C, Talc Type B, magnesia and bauxite that would result in the calculated net magnesia, alumina and silica contents were calculated. The results of these final calculations is reported in Table 6D.

TABLE 6D

| | Kaolin Type | | | |
|---|---|---|---|---|
| No. | C wt. % | Talc Type B wt. % | MgO wt. % | Bauxite wt. % |
| 22 | 78.7 | 0 | 13.3 | 8.0 |
| 23 | 82.5 | 0 | 14.3 | 3.2 |
| 24 | 78.0 | 5.0 | 13.2 | 3.8 |
| 25 | 72.1 | 10.0 | 12.1 | 5.8 |
| 26 | 70.1 | 0 | 10.0 | 19.9 |
| 27 | 81.5 | 0 | 14.0 | 4.5 |
| 28 | 66.1 | 15.0 | 10.9 | 8.0 |

The data above shows that CTEs, from 100 to 1100° C., less than that of zircon sand can be achieved with low cordierite levels (less than about 10 percent by weight) in a cordierite-mullite-sapphirine system, but that higher cordierite levels (greater than about 40 percent by weight) are preferred in a cordierite-mullite-cristobalite system to achieve a similar CTE.

The data shown above in Examples 1-4 and reported in Tables 2C, 3C, 4C, 5D and 6C demonstrate that the desired CTE can be achieved by compositions that include from about 5 to about 90 weight percent cordierite.

### Alternative Embodiment

According to other embodiments, a method other than the mixing method described in Examples 1, 2 and 4 can be used to form substantially round and spherical pellets from any of the blends of raw materials described in Examples 1-4, or other blends of raw materials that provide a net chemistry as described herein. For example, substantially round and spherical pellets can be formed from a slurry of raw materials via a process involving a fluid bed.

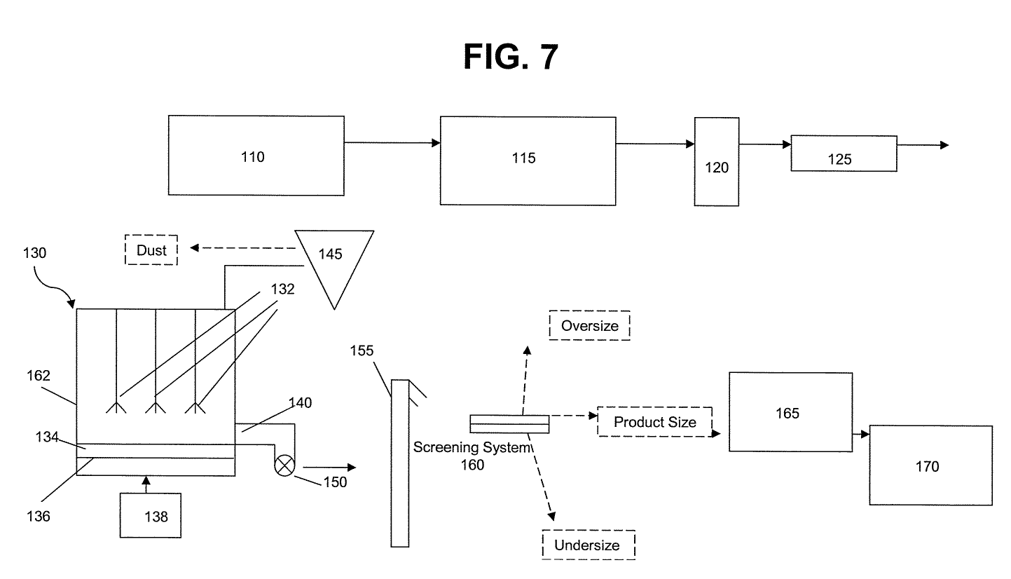

Referring now to FIG. 7, an exemplary system for implementing a continuous process using a fluid bed to prepare substantially round and spherical pellets from a slurry is illustrated. The exemplary system illustrated in FIG. 7 is similar in configuration and operation to that described in U.S. Pat. No. 4,440,866, the entire disclosure of which is hereby incorporated by reference herein.

In the system illustrated in FIG. 7, calcined, uncalcined, or partially calcined raw material of the types and amounts as described in any of the blends described in Examples 1-4, or other blends that provide a net chemistry as described herein, can be added to a blunger 110. The materials can be co-milled prior to addition to the blunger, or can be mixed together therein. Water is added to the blunger to form a slurry of the raw materials. Blungers and similar devices for making slurries of such materials, as well as commercial sources for same, are known to those of ordinary skill in the art. In addition, shredders, milling devices or other devices suitable for breaking up and blending raw materials as described herein can precede or follow the blunger 110.

The amount of water added to the blunger 110 should be that amount that results in the slurry having a solids content in the range of from about 40% to about 60% by weight. The water added to the blunger can be fresh water or deionized water. In a continuous process for preparing the slurry, the solids content of the slurry can be periodically analyzed and the amount of water fed to the slurry adjusted to maintain the desired solids content. Methods for analyzing the solids content of a slurry and adjusting a feed of water are within the ability of those of ordinary skill in the art.

In certain embodiments, dispersant and/or a pH-adjusting reagent can be added to the slurry in the blunger to achieve a target viscosity of the slurry. Dispersants and pH-adjusting reagents for use with a slurry of raw materials as described herein are commercially available, and the selection of a suitable dispersant or pH-adjusting reagent can be made by those of ordinary skill in the art through routine experimentation. The target viscosity is that viscosity that can be processed through a given type and/or size of the pressure nozzle in the subsequent fluidizer, without becoming clogged. Generally, the lower the viscosity of the slurry, the better it can be processed through a given fluidizer. However, at some concentration of dispersant, the dispersant can cause the viscosity of the slurry to increase to a point that it cannot be satisfactorily processed through a given fluidizer. One of ordinary skill in the art can determine the appropriate amount of dispersant and the target viscosity for given fluidizer types through routine experimentation.

If a pH-adjusting reagent is used, then the amount of pH-adjusting reagent added to the slurry should be that amount which gives the slurry the lowest viscosity which is often a pH in the range of from about 8 to about 11. The pH of the slurry can be periodically analyzed by a pH meter, and the amount of pH-adjusting reagent fed to the slurry adjusted to maintain the desired pH. Methods for analyzing the pH of a slurry and adjusting a feed of pH-adjusting reagent are within the ability of those of ordinary skill in the art.

Optionally, a defoamer can be added to the slurry in the blunger. If a defoamer is used, it can be added to the slurry in any amount that reduces or prevents equipment problems caused by foaming of the slurry. Those of ordinary skill in the art can identify and select a suitable defoamer and amount of defoamer to use in the processes described herein through routine experimentation.

The blunger 110 mixes the raw materials, water, and any pH-adjusting reagent, dispersant or defoamer, until a slurry is formed. The amount of time it takes for the slurry to form is understandably dependent on factors such as the size of the blunger, the speed at which the blunger is operating, and the amount of material in the blunger.

From the blunger 110, the slurry is fed to a tank 115, where the slurry is continually stirred, and a binder is added in an amount of from about 0.25 to about 5.0% by weight, based on the total dry weight of the raw materials. Suitable binders include but are not limited to polyvinyl acetate, polyvinyl alcohol (PVA), methylcellulose, dextrin and molasses. In certain embodiments, the binder is a PVA binder having a molecular weight in a range of from about 20,000 to 100,000 Mn. “Mn” is a unit known to those of ordinary skill in the art to indicate the number length average for determining the molecular weight of a chained molecule.

The tank 115 maintains the slurry created by the blunger 110, and stirs the slurry with less agitation than the blunger. This allows the binder to mix with the slurry without causing excessive foaming of the slurry or a viscosity increase in the slurry such that the slurry cannot be subsequently fed through pressurized nozzles of a fluidizer. Tank 115 can also be a tank system comprised of one or more tanks, for example, the tank may be comprised of two, three, or more tanks. Any configuration of tanks or number of tanks that allows for the binder to become thoroughly mixed throughout the slurry is sufficient.

In another embodiment, the slurry is not fed to a tank, rather, the binder can be added to the slurry in the blunger. If such an alternative is used, then the blunger should have variable speeds, including a high speed to achieve the high intensity mixing for breaking down the raw material into a slurry form, and a low speed to mix the binder with the slurry without causing the above-mentioned excessive foaming or viscosity increase.

Referring again to the tank 115 illustrated in FIG. 7, the slurry is stirred in the tank, after addition of the binder, for an amount of time sufficient to allow for the binder to become thoroughly mixed throughout the slurry. In certain embodiments, the amount of time the slurry is stirred in the tank is up to about 30 minutes or more after the binder has been added.

From the tank 115, the slurry is fed to a heat exchanger 120, which heats the slurry to a temperature in a range of from about 25 to about 90° C. From the heat exchanger 120, the slurry is fed to a pump system 125, which feeds the slurry, under pressure, to a fluidizer 130.

A grinding mill(s) and/or a screening system(s) (not illustrated) can be inserted at one or more places in the system illustrated in FIG. 7 prior to feeding the slurry to the fluidizer 130 to assist in eliminating any larger-sized raw material down to a target size suitable for feeding to the fluidizer. In certain embodiments, the target size is less than 230 mesh. In other embodiments, the target size is less than 325 mesh, less than 270 mesh, less than 200 mesh or less than 170 mesh. The target size is influenced by the ability of the type and/or size of the pressure nozzle in the subsequent fluidizer to atomize the slurry without becoming clogged.

If a grinding system is employed, it is charged with a grinding media suitable to assist in breaking the raw material down to a target size suitable for subsequent feeding through one or more pressure nozzles of a fluidizer. If a screening system is employed, the screening system is designed to remove particles greater than the target size from the slurry. Grinding and screening systems are commercially available and known to those of ordinary skill in the art.

Referring again to FIG. 7, fluidizer 130 is of conventional design, as described in, for example, U.S. Pat. No. 3,533,829 and in British Pat. No. 1,401,303. Fluidizer 130 includes at least one atomizing nozzle 132 (three nozzles 132 are illustrated in FIG. 7), which is a pressure nozzle of conventional design. In other embodiments, one or more two-fluid nozzles are suitable. The design of such nozzles is well known, e.g. from K. Masters: “Spray Drying Handbook”, John Wiley and Sons, New York (1979).

Fluidizer 130 further includes a particle bed 134, which is supported by a plate 136, which can be a perforated, straight or directional plate. Hot air flows through the plate 136. The particle bed 134 comprises seeds from which substantially round and spherical pellets of a target size can be grown. If a perforated or straight plate is used, then the seeds also serve to obtain plug flow in the fluidizer. Plug flow is a term known to those of ordinary skill in the art, and can generally be described as a flow pattern where very little back mixing occurs. The seeds are particles that are smaller than the target size for pellets made according to the present methods. In certain embodiments, the seed comprises less than about 20%, less than about 15%, less than about 10%, or less than about 5% of the total volume of a pellet formed therefrom. Slurry is sprayed, under pressure, through the atomizing nozzle or nozzles 132, and the slurry spray coats the seeds to form substantially round and spherical pellets.

External seeds can be placed on the perforated plate 136 before atomization of the slurry by the fluidizer begins. If external seeds are used, the seeds can be prepared in a slurry process similar to that illustrated in FIG. 7, where the seeds are simply taken from the fluidizer at a target seed size. External seeds can also be prepared in a high intensity mixing process such as that described in U.S. Pat. No. 4,879,181 and Examples 1, 2 and 4 herein.

Alternatively, seeds for the particle bed are formed by the atomization of the slurry, thereby providing a method by which the slurry “self-germinates” with its own seed. According to one such embodiment, the slurry is fed through the fluidizer 130 in the absence of a seeded particle bed 134. The slurry droplets exiting the nozzle or nozzles 132 solidify, but are small enough initially that they get carried out of the fluidizer 130 by air flow and caught as “dust” (fine particles) by a dust collector 145, which may, for instance, be an electrostatic precipitator, a cyclone, a bag filter or a wet scrubber or a combination thereof. The dust from the dust collector is then fed to the particle bed 134 through dust inlet 162, where it is sprayed with slurry exiting the nozzle or nozzles 132. The dust may be recycled a sufficient number of times, until it has grown to a point where it is too large to be carried out by the air flow and can serve as seed. The dust can also be recycled to another operation in the process, for example, the tank 115.

Referring again to FIG. 7, hot air is introduced to the fluidizer 130 by means of a fan and an air heater, which are schematically represented at 138. The velocity of the hot air passing through the particle bed 134 can be in a range of from about 0.9 to about 1.5 meters/second, and the depth of the particle bed 134 can be in a range of from about 2 to about 60 centimeters. The temperature of the hot air when introduced to the fluidizer 130 can be in a range of from about 250 to about 650° C. The temperature of the hot air as it exits from the fluidizer 130 is less than about 250° C., and preferably less than about 100° C.

The distance from the atomizing nozzle or nozzles 132 to the plate 136 is adjustable, and the nozzle or nozzles are preferably positioned a rather short distance above the surface of the particle bed 134. The preferred position of the nozzles will vary in each individual case, with due regard to the consideration that when the distance from the nozzles to the surface of the particle bed is too great, undesirable dust is formed because the atomized feed droplets are dried to too high an extent before they reach the particle bed. On the other hand, if the distance from the nozzles to the surface of the particle bed is too small, undesirably irregular and coarse pellets are formed. Therefore, the position of the nozzles is adjusted to avoid the formation of dust and irregular, coarse pellets on the basis of an analysis of powder sampled from the fluidizer. Such adjustments are within the purview of one of ordinary skill in the art.

The pellets formed by the fluidizer accumulate in the particle bed 134, and are withdrawn through an outlet 140 in response to the level of product in the particle bed, so as to maintain a given depth in the particle bed. A rotary valve 150 conducts pellets withdrawn from the fluidizer 130 to an elevator 155, which feeds the pellets to a screening system 160, where the pellets are separated into one or more fractions, for example, an oversize fraction, a product fraction, and an undersize fraction.

The oversize fraction includes those pellets that are larger than the desired product size. Oversize pellets can be recycled to tank 115, where at least some of the pellets can be broken down and blended with slurry in the tank, or can be broken down and recycled to the particle bed 134 in the fluidizer 130. The undersized fraction includes those pellets that are smaller than the desired product size. Undersized pellets can be recycled to the fluidizer 130, where they can be fed through inlet 162 as seeds or as a secondary feed to the fluidizer.

The product fraction exiting the screening system 160 includes those pellets having the desired product size. These particles are sent to a pre-sintering device 165, for example, a calciner, where the particles are dried or calcined prior to sintering. In certain embodiments, the particles are dried to a moisture content of less than about 18% by weight, or less Iran about 15%, less than about 12%, less than about 10%, less than about 5%, or less than about 1% by weight.

After drying and/or calcining, the pellets can be fed to a sintering device 170, in which the pellets can be sintered under conditions as described in Examples 1, 2 and 4, or under other conditions suitable to sinter the pellets without melting. As an alternative, the pre-sintering device 165 can be eliminated if the sintering device 170 can provide sufficient calcining and/or drying conditions (i.e., drying times and temperatures that dry the pellets to a target moisture content prior to sintering), followed by sufficient sintering conditions.

Pellets produced by the foregoing method would have properties substantially similar to those produced by the mixing method described in Examples 1, 2 and 4. In particular, the pellets produced by the method described in this alternative embodiment would have a low coefficient of thermal expansion.

### Alternative Embodiment

According to another embodiment, a spray drying method can be used to form substantially round and spherical pellets from any of the blends described in Examples 1-4, or other blends that provide a net chemistry as described herein. Spray drying methods are known to those of ordinary skill in the art and generally involve the atomization of a fluid feedstock into sprays of droplets, which are dried to individual pellets on contact with hot air.

According to a method illustrated by this embodiment, a slurry comprising water and any of the blends described in Examples 1-4, or other blends that provide a net chemistry as described herein, can be prepared by blending, mixing, agitating or similar means known to those of ordinary skill in the art, the raw materials and the water. The raw materials in the blend can be calcined, uncalcined, partially calcined, or mixtures thereof.

In certain embodiments, the slurry can further comprise a binder, such as polyvinyl alcohol, polyvinyl acetate, methylcellulose, dextrin and molasses. Binders are typically organic materials used to increase green particle strength. In certain embodiments, water can act as a binder. In still other embodiments, the slurry further comprises a dispersant, such as a colloid, a polyelectrolyte, tetra sodium pyrophosphate, tetra potassium pyrophosphate, polyphosphate, ammonium citrate, ferric ammonium citrate, and sodium hexametaphosphate. Dispersants are included to enhance the total solids content of the slurry by reducing the slurry viscosity. The amount of dispersant, if any, to be used in a slurry is balanced between the ability to atomize the slurry and the ability to make solid substantially round and spherical pellets.

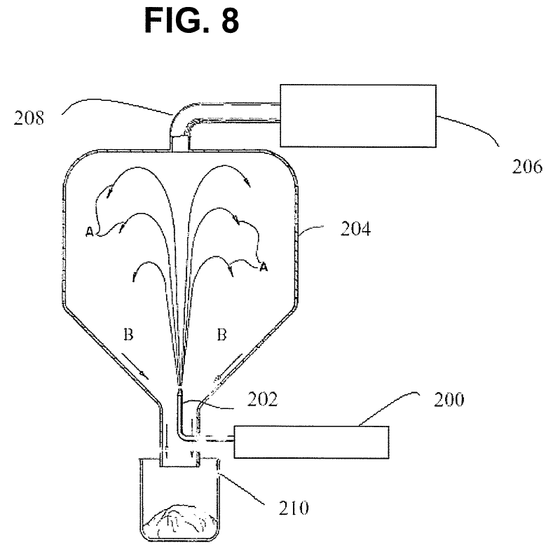

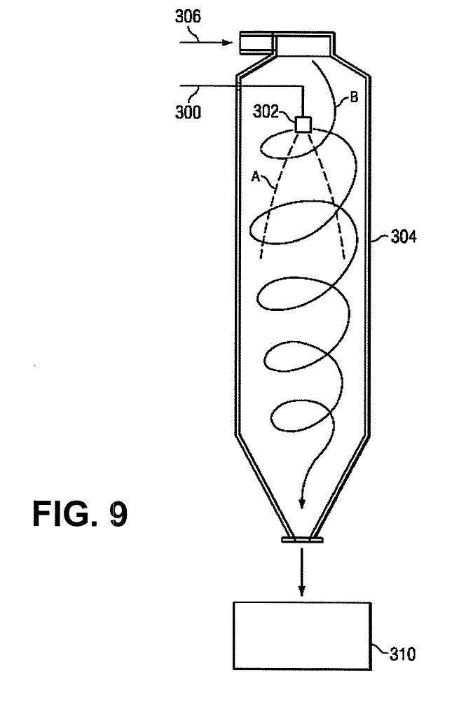

The relative quantities of raw starting materials (individually or as a blend), water, binder (if any) and dispersant (if any) in the slurry depend on the desired properties for the solid ceramic proppant, but are limited to those amounts that will make the slurry suitable for pumping through a nozzle or rotating wheel in atomization process 202 or 302 as illustrated schematically in FIGS. 8 and 9, respectively, and will allow for the production of green particles that can be sintered to form solid ceramic particles that are substantially round and spherical. In certain embodiments, the slurry has a solids content in the range of from about 50 to about 75% by weight, while in other embodiments, the solids content is from about 50 to about 60% by weight, or from about 60 to about 70% by weight.

In embodiments where the slurry comprises a binder, the amount of binder can be less than about 0.5 percent by weight of the dry ceramic starting material, or less than about 1.0 percent by weight of the dry ceramic starting material.

In embodiments where the slurry comprises a dispersant, the amount of dispersant can be less than about 0.3 percent by weight of the dry ceramic starting material, less than about 0.5 percent by weight of the dry ceramic starting material, or less than about 1.0 percent by weight of the dry ceramic starting material.

The slurry is fed to a spray drying apparatus having atomizing equipment. Suitable atomizing equipment includes but is not limited to a rotary wheel atomizer, a pressure nozzle atomizer and a dual fluid nozzle atomizer. Rotary wheel, pressure nozzle and dual fluid nozzle atomizers are known to those of ordinary skill in the art, and include those in spray dryers commercially available from a variety of sources, such as Niro, Inc. Nozzle design is known and understood by those of ordinary skill in the art, e.g. K. Masters: “Spray Drying Handbook”, John Wiley and Sons, New York (1979).

Whether to use a rotary wheel, pressure nozzle, or dual fluid nozzle atomizer depends upon properties, such as size, distribution, and shape, desired in the final dried solid ceramic particle along with the desired production capacity. Generally, rotary wheel atomizers produce fine particles, while pressure nozzles and dual fluid nozzles operated under pressure can produce comparatively larger particles.

When a rotary wheel atomizer is used, slurry is fed to the center of the rotating wheel of the atomizer, and moves to the periphery of the wheel by centrifugal force. Atomization takes place at the wheel edge. The size of droplets and the size distribution of droplets in the resulting spray depend upon the amount of energy imparted to the slurry and the frictional effects between the newly formed droplets and the turbulent air flow near the wheel. Sprays of droplets are ejected horizontally from the wheel but quickly follow the airflow patterns created by an air disperser, which directs the hot air down into a drying chamber in a controlled manner. The particle size of pellets produced in spray dryers with rotary wheel atomizers increases with a decrease in atomizer wheel speed. The effect of feed rate is not great within the optimum working range of the given atomizer wheel, and fluctuations in feed rate during operation do not change the size distribution of the ceramic powder produced. Chamber diameters used with rotary wheel atomizers should generally be large enough to prevent the formation of semi-wet deposits at the chamber wall at the atomizer level. In contrast, chambers of smaller diameter but larger cylindrical height can be used with pressure nozzle and dual fluid nozzle atomizers.

When a pressure nozzle atomizer is used, slurry is fed to the nozzle under pressure. In the case of a dual fluid nozzle, slurry and compressed air are fed through separate nozzles. The feed of air is pressurized, while the feed of slurry can be pressurized or a siphon/gravity feed.

Pressure energy is converted into kinetic energy, and the slurry flows from the nozzle orifice as a high-speed film that readily disintegrates into droplets. The droplet size produced from a pressure nozzle atomizer or pressurized dual fluid nozzle varies inversely with pressure and directly with feed rate and feed viscosity. The capacity of a pressure nozzle or pressurized dual fluid nozzle varies with the square root of pressure. In certain embodiments where high feed rates and/or high-capacity spray drying is desired, multi-nozzle systems are used.

Droplets of slurry exiting the atomizing equipment meets hot drying air entering a drying chamber. How the droplets and drying air are initially contacted, and how the droplets/particles move throughout the drying chamber can generally be described as co-current, counter-current, or a combination thereof. In certain embodiments, such as the one illustrated in FIG. 8, a drying chamber providing a combination of co-current and counter-current flow is illustrated in use with a pressure nozzle atomizer.

FIG. 8 is a simplified diagram of a spray drying apparatus comprising a drying chamber 204 and a pressure nozzle 202. Spray dryers typically include additional components, which need not be detailed herein, as spray dryers and their components are known to those of ordinary skill in the art. In FIG. 8, a slurry comprising a blend of raw materials as described herein is fed from a feed source 200 through a pressure nozzle 202. Although only one pressure nozzle is illustrated in FIG. 8, multiple nozzles can be used. Various types of equipment suitable for feeding a slurry are known to those of ordinary skill in the art, and can include, for example, a feed pump with or without a filter. The pressure nozzle 202 atomizes the slurry into droplets and sprays the droplets upward into the dryer chamber 204, which is illustrated by arrows A. Hot air is fed into the drying chamber 204 from an air source 206, through an inlet 208 and enters the drying chamber 204 where it contacts the slurry droplets. Thus, the hot air enters from a point above the point at which the slurry is sprayed into the drying chamber, and flows in a generally downward direction in the chamber. Initially, the slurry droplets flow in a generally upward direction in the drying chamber, thereby establishing a counter-current flow. At some point, however, the droplets will exhaust their vertical trajectory, and begin to flow in a generally downward direction in the chamber, thereby establishing a co-current flow. Droplets in a drying chamber such as that illustrated in FIG. 8 have an extended vertical trajectory, which allows a longer airborne time for drying. Although FIG. 8 illustrates a pressure nozzle atomizer in use with a combination co-current and counter-current drying chamber, such drying chambers can also be used with rotary wheel atomizers and dual fluid nozzle atomizers.

In certain embodiments, such as that illustrated in FIG. 9, a co-current drying chamber is used with a pressure nozzle atomizer. FIG. 9 is a simplified diagram of a spray drying apparatus comprising a drying chamber 304 and a pressure nozzle 302. Slurry is fed from a feed source 300 through a pressure nozzle 302. The pressure nozzle 302 atomizes the slurry into droplets and sprays the droplets in a generally downward direction (illustrated at “A”) into the dryer chamber 304. Hot air is fed into the drying chamber 304 from an air source 306, and flows into the drying chamber 304 in a generally downward direction (illustrated at “B”). Thus, the hot air and the slurry droplets flow in a generally downward direction in the chamber, thereby establishing a concurrent flow. Although FIG. 9 illustrates a pressure nozzle atomizer in use with a co-current drying chamber, concurrent drying chambers can also be used with rotary wheel atomizers and dual fluid nozzle atomizers.

Various types of equipment suitable for feeding hot air into the drying chamber for drying of the droplets are known to those of ordinary skill in the art, and can include, for example, a heater with or without an air filter. In the drying chamber, green ceramic particles form as moisture is evaporated from the droplets. As the slurry is sprayed into drying chamber 304 and contacts hot drying air, evaporation from the surface of the droplet occurs and a saturated vapor film forms at the surface of the droplet. Dispersants and binders, if present, are soluble. Thus, when a dispersant and/or binder is present, each atomized spray droplet contains both insoluble ceramic material and soluble additives. During the evaporation phase of spray drying, the soluble binding materials coat themselves in a film on the droplet surface.

As drying continues, moisture toward the interior of the droplet evaporates. According to the methods described herein, moisture from the interior of the droplet is evaporated at least in part by diffusion through the solid particles packed in the droplet, toward the droplet surface, and then through the film on the droplet surface. As evaporation of moisture from the droplet interior occurs, the film on the droplet surface grows inward toward the droplet interior.

Droplet surface temperatures are low in spite of the relatively higher inlet air temperature of the drying air. Evaporation takes place initially under constant-rate conditions, but then the rate falls as the droplets approach a final residual moisture content condition. Since the droplets contain undissolved solids, the drying profile features a significant constant-rate period that contributes to the particle sphericity. During drying, the spray droplet size distribution changes as droplets change size during evaporation of moisture. Coalescence of droplets and particles can also occur, and may be due to the turbulent air flow pattern in the drying chamber and the complex distribution of temperature and humidity levels.

Because the droplets generally do not rotate as they are projected through the drying chamber, one side of the droplet can be exposed to air from the inlet that is hotter than the air to which the other side of the droplet is exposed (referred to herein as the “hot side” and the “cool side”, respectively). In such instances, evaporation is faster on the hotside, and the film that forms on the surface of the droplet thickens more rapidly on the hot side than on the cool side. Liquid and solids in the droplet migrate to the hot side. At this point, it would be expected that the cool side would be drawn inward, which would result in a hollow green particle with a dimple, rather than the solid green particles described herein. However, according to the methods described herein, the particles are solid rather than hollow because of one or more of the following factors: solids content in the weight percents described herein, solubles content (dispersant and/or binder) in the weight percents described herein, and air inlet temperatures in the ranges as described herein.

Regarding the solids content, slurries having solids contents greater than about 50 weight percent can be used to produce solid substantially round and spherical particles as described herein. In certain embodiments, the slurry has a solids content in the range of from about 50 to about 75% by weight, while in other embodiments, the solids content is from about 50 to about 60% by weight, or from about 60% to about 70% by weight.

Regarding the solubles content, binders increase slurry viscosity, which can lead to the need to reduce the solids content in order to maintain a slurry that can be atomized. Lower solids content, however, can lead to a particle that is not solid. As for dispersants, dispersants allow more rapid movement of solids to the surface of the particle, which can also lead to a particle that is not solid. Thus, the solubles content in a slurry (amounts of additives such as binders and dispersants) should be balanced against the solids content of the slurry. Preferably, the least amount of binder and/or dispersant, as determined by the need to adjust viscosity of the slurry, is used.

Regarding the air inlet temperatures, the temperature of the air entering a drying chamber is controlled according to methods described herein. Thus, in certain embodiments, the air inlet temperature is in a range of from about 100° C. to about 200° C., or from about 200° C. to about 300° C., or from about 300° C. to about 400° C., or from about 400° C. to about 500° C. In other embodiments, the air inlet temperature is in a range of from about 150° C. to about 200° C. or from about 200° C. to about 250° C. Preferably, temperatures in the lower end of such ranges are used in order to slow the rate of drying of the particles, which in turn contributes to the production of green ceramic particles that can be sintered to produce solid ceramic particles that are substantially round and spherical.

In the schematics illustrated in FIGS. 8 and 9, the green ceramic particles are discharged from the drying chamber into a discharge 210 and 310 at least in part under the influence of gravity. In addition to the components illustrated in FIGS. 8 and 9, suitable drying arrangements can further include fans and ducts, exhaust air cleaning equipment (cyclones, baghouses, scrubbers), and control instrumentation. Such further components and equipment, and their use in a spray drying method as described herein, are known to those of ordinary skill in the art.

After discharge, the green ceramic particles can be sintered using conventional sintering equipment to form solid ceramic particles that are substantially round and spherical. The pellets produced by the foregoing method would have properties substantially similar to those produced by the mixing method described in Examples 1, 2 and 4. In particular, the pellets produced by the method described in this alternative embodiment would have a low coefficient of thermal expansion.

It will be obvious to those skilled in the art that the invention described herein can be essentially duplicated by making minor changes in the material content or the method of manufacture. To the extent that such material or methods are substantially equivalent, it is intended that they be encompassed by the following claims.

1. A method for forming a foundry media comprising:
forming substantially round and spherical green pellets from raw materials comprising water, a magnesia source, a silica source and an alumina source; and
sintering the pellets to form the foundry media,
wherein the foundry media so formed has a coefficient of thermal expansion, from about 100° C. to about 1100° C., less than at least one of silica sand, olivine sand and zircon sand.

2. The method of claim 1 wherein the foundry media has a coefficient of thermal expansion, from about 100° C. to about 1100° C., selected from the group consisting of: less than about 15 (10⁻⁶ inch per inch per ° C.), less than about 12 (10⁻⁶ inch per inch per ° C.), less than about 7 (10⁻⁶ inch per inch per in ° C.), less than about 6 (10⁻⁶ inch per inch per ° C.), less than about 5 (10⁻⁶ inch per inch per ° C.), and less than about 4.0 (10⁻⁶ inch per inch per ° C.).

3. The method of claim 1 wherein the foundry media comprises cordierite in an amount selected from the group consisting of at least 25 percent by weight, at least 40 percent by weight, at least 45 percent by weight, at least 50 percent by weight, at least 55 percent by weight, at least 60 percent by weight, at least 65 percent by weight, at least 70 percent by weight, at least 75 percent by weight, at least 80 percent by weight and at least 85 percent by weight.

4. The method of claim 1 wherein the foundry media comprises cordierite in an amount selected from the group consisting of at least 25 percent by weight, at least 40 percent by weight, at least 50 percent by weight, at least 60 percent by weight aid at least 80 percent by weight.

5. The method of claim 1 wherein the foundry media comprises cordierite in an amount of from about 5 percent by weight to about 90 percent by weight.

6. The method of claim 1 wherein the foundry media comprises cordierite in an amount of from about 5 percent by weight to about 30 percent by weight.

7. The method of claim 1 wherein the foundry media comprises cordierite in an amount of from about 45 percent by weight to about 65 percent by weight.

8. The method of claim 1 wherein the foundry media comprises cordierite in an amount of from about 52 to about 66 percent by weight, mullite in an amount of from about 7 to about 24 percent by weight and sapphirine in an amount of from about 1 to about 8 percent by weight.

9. The method of claim 1 wherein the foundry media comprises cordierite in an amount of from about 25 to about 42 percent by weight, mullite in an amount of from about 19 to about 21 percent by weight, and sapphirine in an amount of from about 7 to about 11 percent by weight.

10. The method of claim 1 wherein the foundry media comprises cordierite in an amount of about 71 percent by weight, mullite in an amount of about 20 percent by weight, and sapphirine in an amount of about less than 1 percent by weight.

11. The method of claim 1 wherein the foundry media comprises cordierite in an amount of from about 80 to about 90 percent by weight, mullite in an amount of from about 3 to about 10 percent by weight, and sapphirine in an amount of from about 0 to about 16 percent by weight.

12. The method of claim 1 wherein the foundry media comprises cordierite in an amount of about 64 percent by weight, mullite in an amount of about 20 percent by weight, and cristobalite in an amount of about 7 percent by weight.

13. The method of claim 1 wherein the foundry media comprises cordierite in an amount of about 82 percent by weight, mullite in an amount of about 13 percent by weight, and cristobalite in an amount of about 5 percent by weight.

14. The method of claim 1 wherein the magnesia source, the silica source and the alumina source provide a net chemistry located in the cristobalite-mullite-cordierite region of a magnesia-alumina-silica phase diagram.

15. The method of claim 14 wherein the net chemistry is such that magnesia is present in an amount of from about 7 to about 14 percent by weight, alumina is present in an amount of from about 17 to about 54 percent by weight, and silica is present in an amount of from about 39 to about 76 percent by weight.

16. The method of claim 15 wherein the foundry media comprises at least 50 percent by weight cordierite.

17. The method of claim 14 wherein the net chemistry is such that magnesia is present in an amount of from about 9 to about 16 percent by weight, alumina is present in an amount of from about 36 to about 49 percent by weight, and silica is present in an amount of from about 37 to about 51 percent by weight.

18. The method of claim 1 wherein the magnesia source, the silica source and the alumina source provide a net chemistry located in the sapphirine-mullite-cordierite region of a magnesia-alumina-silica phase diagram.

19. The method of claim 18 wherein the net chemistry is such that magnesia is present in an amount of from about 7 to about 18 percent by weight, alumina is present in an amount of from about 34 to about 54 percent by weight, and silica is present in an amount of from about 33 to about 52 percent by weight.

20. The method of claim 19 wherein the foundry media comprises at least 50 percent by weight cordierite.

21. The method of claim 18 wherein the net chemistry is such that magnesia is present in an amount of from about 10 to about 15 percent by weight, alumina is present in an amount of from about 39 to about 49 percent by weight, and silica is present in an amount of from about 24 to about 47 percent by weight.

22. The method of claim 1 wherein the alumina source comprises at least one of kaolin and bauxite.

23. The method of claim 1 wherein the silica source comprises at least one of kaolin, bauxite, talc and olivine sand.

24. The method of claim 1 wherein the magnesia source comprises at least one of magnesium oxide, talc and olivine sand.

25. The method of claim 1 further comprising co-milling the magnesia source, the alumina source and the silica source prior to forming the substantially round and spherical pellets.

26. The method of claim 1 wherein the forming of the substantially round and spherical pellets comprises mixing the water, magnesia source, alumina source and silica source in a high intensity mixer.

27. The method of claim 1 wherein the forming of the substantially round and spherical pellets comprises forming a slurry comprising the water, magnesia source, alumina source and silica source, and feeding the slurry through an atomizer to form the pellets.

28. The method of claim 1 wherein the forming of the substantially round and spherical pellets comprises forming a slurry comprising the water, magnesia source, alumina source and silica source, and feeding the slurry through a spray dryer to form the pellets.

29. Foundry media comprising sintered substantially round and spherical pellets formed from a magnesia source, a silica source and an alumina source, and having a coefficient of thermal expansion, from about 100° C. to about 1100° C., less than at least one of silica sand, olivine sand and zircon sand.

30. The foundry media of claim 29 having a coefficient of thermal expansion, from about 100° C. to about 1100° C., selected from the group consisting of: less than about 15 (10⁻⁶ inch per inch per ° C.), less than about 12 (10⁻⁶ inch per inch per ° C.), less than about 7 (10⁻⁶ inch per inch per ° C.), less than about 6 (10⁻⁶ inch per inch per ° C.), less than about 5 (10⁻⁶ inch per inch per ° C.), and less than about 4.0 (10⁻⁶ inch per inch per ° C.).

31. The foundry media of claim 29 comprising cordierite in an amount selected from the group consisting of at least 25 percent by weight, at least 40 percent by weight, at least 45 percent by weight, at least 50 percent by weight, at least 55 percent by weight, at least 60 percent by weight, at least 65 percent by weight, at least 70 percent by weight, at least 75 percent by weight, at least 80 percent by weight and at least 85 percent by weight.

32. The foundry media of claim 29 comprising cordierite in an amount selected from the group consisting of at least 25 percent by weight, at least 40 percent by weight, at least 50 percent by weight, at least 60 percent by weight and at least 80 percent by weight.

33. The foundry media of claim 29 comprising cordierite in an amount of from about 5 percent by weight to about 90 percent by weight.

34. The foundry media of claim 29 comprising cordierite in an amount of from about 5 percent by weight to about 30 percent by weight.

35. The foundry media of claim 29 comprising cordierite in an amount of from about 45 percent by weight to about 65 percent by weight.

36. The foundry media of claim 29 comprising cordierite in an amount of from about 52 to about 66 percent by weight, mullite in an amount of from about 7 to about 24 percent by weight and sapphirine in an amount of from about 1 to about 8 percent by weight.

37. The foundry media of claim 29 comprising cordierite in an amount of from about 25 to about 42 percent by weight, mullite in an amount of from about 19 to about 21 percent by weight, and sapphirine in an amount of from about 7 to about 11 percent by weight.

38. The foundry media of claim 29 comprising cordierite in an amount of about 71 percent by weight, mullite in an amount of about 20 percent by weight, and sapphirine in an amount of about less than 1 percent by weight.

39. The foundry media of claim 29 comprising cordierite in an amount of from about 80 to about 90 percent by weight, mullite in an amount of from about 3 to about 10 percent by weight, and sapphirine in an amount of from about 0 to about 16 percent by weight.

40. The foundry media of claim 29 comprising cordierite in an amount of about 64 percent by weight, mullite in an amount of about 20 percent by weight, and cristobalite in an amount of about 7 percent by weight.

41. The foundry media of claim 29 comprising cordierite in an amount of about 82 percent by weight, mullite in an amount of about 13 percent by weight, and cristobalite in an amount of about 5 percent by weight.

42. The foundry media of claim 29 wherein the magnesia source, the silica source and the alumina source provide a net chemistry located in the cristobalite-mullite-cordierite region of a magnesia-alumina-silica phase diagram.

43. The foundry media of claim 42 wherein the net chemistry is such that magnesia is present in an amount of from about 7 to about 14 percent by weight, alumina is present in an amount of from about 17 to about 54 percent by weight, and silica is present in an amount of from about 39 to about 76 percent by weight.

44. The foundry media of claim 43 wherein the foundry media comprises at least 50 percent by weight cordierite.

45. The foundry media of claim 42 wherein the net chemistry is such that magnesia is present in an amount of from about 9 to about 16 percent by weight, alumina is present in an amount of from about 36 to about 49 percent by weight, and silica is present in an amount of from about 37 to about 51 percent by weight.

46. The foundry media of claim 29 wherein the magnesia source, the silica source and the alumina source provide a net chemistry located in the sapphirine-mullite-cordierite region of a magnesia-alumina-silica phase diagram.

47. The foundry media of claim 46 wherein the net chemistry is such that magnesia is present in an amount of from about 7 to about 18 percent by weight, alumina is present in an amount of from about 34 to about 54 percent by weight, and silica is present in an amount of from about 33 to about 52 percent by weight.

48. The foundry media of claim 47 wherein the foundry media comprises at least 50 percent by weight cordierite.

49. The foundry media of claim 46 wherein the net chemistry is such that magnesia is present in an amount of from about 10 to about 15 percent by weight, alumina is present in an amount of from about 39 to about 49 percent by weight, and silica is present in an amount of from about 24 to about 47 percent by weight.

50. The foundry media of claim 29 wherein the alumina source comprises at least one of kaolin and bauxite.

51. The foundry media of claim 29 wherein the silica source comprises at least one of kaolin, bauxite, talc and olivine sand.

52. The foundry media of claim 29 wherein the magnesia source comprises at least one of magnesium oxide, talc and olivine sand.
